(19) United States
(12) Patent Application Publication
(10) Pub. No.: US 2026/0368172 A1
(43) Pub. Date: Nov. 19, 2026

(54) ADAPTIVE FILTER-AWARE SEARCHING FOR DATABASE SEARCH SYSTEMS

(71) Applicant: Microsoft Technology Licensing, LLC, Redmond, WA (US)

(72) Inventor: Haiyang XU, Kirkland, WA (US)

(21) Appl. No.: 19/292,618

(22) Filed: Aug. 6, 2025

Related U.S. Application Data
(60) Provisional application No. 63/808,448, filed on May 19, 2025.

(51) Int. Cl. G06F 16/2453; G06F 16/901

(52) U.S. Cl. CPC G06F 16/24545; G06F 16/9024

(57) ABSTRACT

Systems, methods, devices, and computer readable storage media described herein provide techniques for filter-aware searching. In an aspect, a search query for querying a database is received. A filter criterion is determined based on the query or metadata related to the query. An inverted index is generated based on the filter criterion and a graph index of the database. The inverted index is utilized to determine a level of selectivity of the query. A search strategy is selected based on the determined level of selectivity having a relationship with a threshold. The selected search strategy is utilized to generate a search result. The search result is provided as a response to the query. In another aspect, a training system is utilized to determine the threshold and cause a search system to select a search strategy based on the level of selectivity of the query having a relationship with the threshold.

### CROSS-REFERENCE TO RELATED APPLICATIONS

This application claims the benefit of U.S. Provisional Patent Application No. 63/808,448, filed May 19, 2025, and titled “ADAPTIVE FILTER-AWARE GRAPH SEARCH FOR EFFICIENT FILTER VECTOR QUERYING IN DISTRIBUTED DATABASES,” which is incorporated by reference herein in its entirety.

### BACKGROUND

Search systems can implement a search technique to find a search result satisfying a search query in a database. Such search systems can leverage vector similarity search techniques to identify a search result. In vector similarity search systems, a query vector is generated for a search query. Vectors representative of files of the database are searched to find a vector that has a level of semantic similarity to the query vector. As database systems become more complex and increase in size, the time spent and compute resources expended in generating an accurate search result also increases.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments of filter aware search are disclosed herein. In an aspect, a search query for querying a database is received. A filter criterion is determined based on the search query or metadata related to the search query. An inverted index is generated based on the filter criterion and a graph index of the database. The inverted index is utilized to determine a level of selectivity of the search query. A search strategy is selected based on the determined level of selectivity. The selected search strategy is utilized to generate a search result. The search result is provided as a response to the search query.

In another aspect, a training system is utilized to train a search system in selecting a search strategy. The training system evaluates a first performance result of a graph search system utilizing a graph-index-based search strategy and a second performance result of an alternative search system utilizing an alternative search strategy. A predetermined threshold is determined based on the evaluation results of the first and second performance results. The training system causes a search system to utilize the graph search system if a level of selectivity of a search query has a first predetermined relationship with the predetermined threshold and to utilize the alternative search system if the level of selectivity has a second predetermined relationship with the predetermined threshold.

Further features and advantages of the embodiments, as well as the structure and operation of various embodiments, are described in detail below with reference to the accompanying drawings. It is noted that the claimed subject matter is not limited to the specific examples described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments and, together with the description, further serve to explain the principles of the embodiments and to enable a person skilled in the pertinent art to make and use the embodiments.

FIG. 1 shows a block diagram of a system for filter-aware graph searching, in accordance with an example embodiment.

FIG. 2 shows a block diagram of a system including the search system of FIG. 1, in accordance with an example embodiment.

FIG. 3 shows a flowchart of a process for filter-aware graph searching, in accordance with an example embodiment.

FIG. 4 shows a flowchart of a process for generating an inverted index, in accordance with an example embodiment.

FIG. 5 shows a flowchart of a process for generating an inverted index utilizing a bit set, in accordance with an example embodiment.

FIG. 6 shows a flowchart of a process for selecting and using a search strategy based on selectivity, in accordance with an example embodiment.

FIG. 7 shows a flowchart of a process for selecting and using a graph-index-based search strategy or an alternative search strategy, in accordance with an example embodiment.

FIG. 8 shows a flowchart of a process for selecting and using an alternative search strategy, in accordance with an example embodiment.

FIG. 9 shows a block diagram of a graph index, in accordance with an example embodiment.

FIG. 10 shows a flowchart of a process for using a graph-index-based search strategy, in accordance with an example embodiment.

FIG. 11 shows a flowchart of a process for applying weights to nodes in a graph index, in accordance with an example embodiment.

FIG. 12 shows a block diagram of a system for training a search system, in accordance with an example embodiment.

FIG. 13 shows a flowchart of a process for training a search system, in accordance with an example embodiment.

FIG. 14 shows a flowchart of a process for training a search system with multiple predetermined thresholds, in accordance with an example embodiment.

FIGS. 15 and 16 show graphs of search strategy performances, in accordance with an example embodiment.

FIG. 17 shows a block diagram of an example computing environment in which embodiments may be implemented.

The subject matter of the present application will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Embodiments for Adaptive Filter-Aware Graph Searching

Search systems are utilized to query a database or other type of data management system. An example of a search system is a vector similarity search system. In a vector similarity search system, vector embeddings are generated and stored in an index. The vector embeddings are information dense representations of data that are floating-point numbers such that the distance between two vector embeddings in vector space is correlated with the semantic similarity between two inputs in their original format. The search system searches through the index with a query vector embedding representing a received query to locate relevant results. A search system can implement an approximate nearest-neighbor search to locate vector embeddings of documents that are relatively close in distance to the query vector embedding.

In some situations, a filter is applied to data to improve relevance, such as filtering by date or location in the query. In existing search systems, the amount of time spent and compute resources utilized in order to search through databases increases as filters are applied to the query. As the size of a database increases, the amount of time spent and compute resources utilized further increases. This occurs when the search system is expending resources scanning irrelevant data. Some existing techniques utilize separate indexes for each type of filter in order to mitigate these issues; however, this can be impractical as support for multiple types of filters increases. Furthermore, a separate index would have to be generated for combinations of indexes. Building these separate indexes further increases storage space consumed for index storage, further increases complexity in maintaining the indexes and associated systems, and further reduces update agility as many indexes would require updates whenever changes are made to filters.

The present application discloses techniques for filter aware graph searching. A search system receives a query for querying a database and determines filter criteria associated with the query. The search system generates an inverted index based on the filter criteria. An inverted index is a data structure that can be utilized to efficiently retrieve documents or other files containing a specific term, a set of terms, or satisfying other criteria. An inverted index organizes an index by terms where each term points to one or more documents or other files that contain that term. A level of selectivity of the inverted index is determined to have a predetermined relationship with a predetermined threshold. The level of selectivity of the inverted index is an indication of how many files of a database satisfy the filter criterion or filter criteria of the query. A search strategy is selected based on the level of selectivity and is used to generate a search result satisfying the query.

By implementing filter aware graph searching in this manner, the search system can select a search strategy from a set of search strategies that has a relatively high likelihood of improving search performance compared to the other search strategies. Thus, the compute resources expended in searching for a search result that satisfies the received query are reduced. Furthermore, the latency in returning a result to a query is reduced. By reducing latency in satisfying queries in this manner, systems that rely on search systems for performing various functions can be improved.

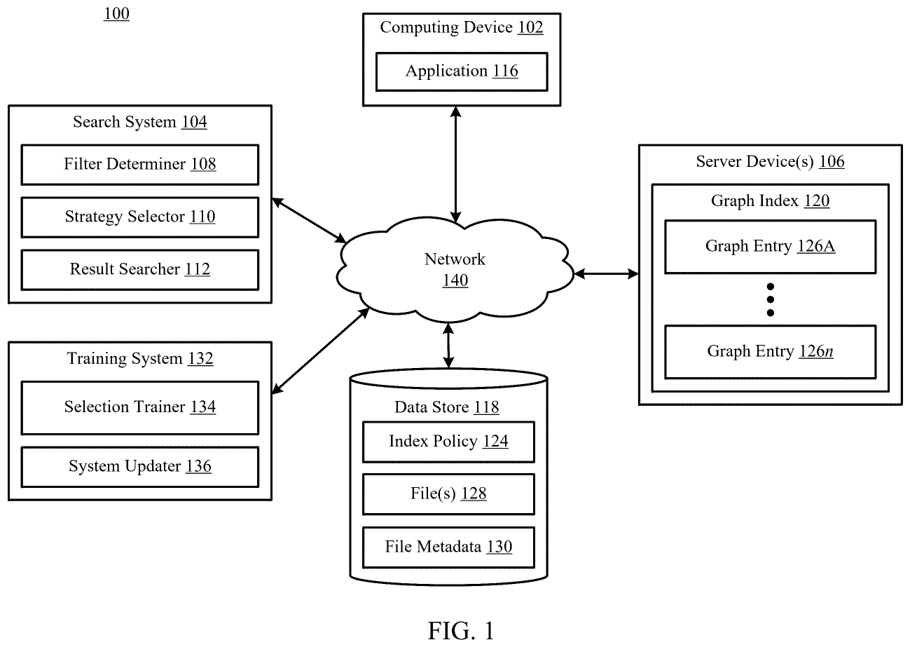

Systems for improving filtered vector search in databases can be configured in various ways in embodiments. For instance, FIG. 1 shows a block diagram of a system 100 for filtered vector search in a database, in accordance with an example embodiment. System 100 is a computing network system, such as an enterprise network system, a cloud computing system, or the like. As shown in FIG. 1, system 100 comprises a computing device 102, a search system 104, one or more server devices 106 (“servers 106” herein), data store 118, and a training system 132. In an embodiment, computing device 102, search system 104, servers 106, data store 118, and training system 132 are interconnected via a network 140. In examples, network 140 comprises one or more networks such as local area networks (LANs), wide area networks (WANs), enterprise networks, the Internet, etc. In examples, network 140 comprises one or more wired and/or wireless portions. The features of system 100 are described in detail as follows.

Data store 118 is any type of physical storage device, including but not limited to, storage disks, solid-state drives (SSDs), random access memory (RAM) devices, flash memory, digital video disks, and/or other types of physical/tangible hardware storage media. Data store 118 stores data generated by and/or obtained by computing device 102, search system 104, servers 106, and/or training system 132. As shown in FIG. 1, data store 118 stores an index policy 124, one or more files 128 (“files 128” herein), and file metadata 130. In an embodiment, index policy 124 specifies a policy of an index, such as a graph index. Files 128 are document files, table files, and/or any other type of file stored and/or utilized by a network computing system. File metadata 130 comprises metadata files corresponding respective files of files 128. A metadata file describes information providing context and details about the data of a corresponding file. Examples of metadata include, but are not limited to, a name of the file, a size of the file, the creation date of the file, an author of the file, and/or other attributes of the file and/or data within.

Computing device 102 is any type of stationary or mobile processing device, including, but not limited to, a desktop computer, a server, a mobile or handheld device (such as a tablet, a personal data assistant (PDA), a smart phone, a laptop, etc.), an Internet-of-Things (IoT) device, etc. In accordance with an embodiment, computing device 102 is associated with a user (such as an individual user, a group of users, an organization, a family user, a customer user, an employee user, an admin user (such as a service team user, a developer user, a management user, etc.), etc.). Computing device 102 is configured to execute an application 116. Application 116 is any type of application for searching or querying for data. Examples of application 116 include, but are not limited to, search engine applications, data repository applications, data management applications, web browsers, and/or the like. In an implementation wherein application 116 is a web browser, a user of computing device 102 can interact with computing device 102 to cause the web browser to navigate to a web page for searching for data. Examples of such web pages include, but are not limited to, search engine websites, websites with local search tools, data management websites, and/or other types of websites that provide search capabilities. In accordance with an embodiment, application 116 enables a user to interface with search system 104, one or more of servers 106, data store 118, and/or training system 132.

Servers 106 are part of a server infrastructure. In an embodiment, the server infrastructure is a network-accessible set of one or more servers and/or other types of computing devices (e.g., such as servers 106). Examples of a server infrastructure include, but are not limited to, cloud-based server sets, enterprise network server set, and/or the like. Servers 106 can include one server, more than one server, tens of servers, hundreds of servers, and/or even greater numbers of servers. Servers 106 can be implemented in a single location, such as a server rack, a room of a building, a data center, and/or the like. Alternatively, servers 106 are distributed across multiple locations, such as in different collocated buildings, distributed servers, across separate data centers, and/or the like. Servers 106 are configured to store data. For instance, as shown in FIG. 1, servers 106 store a graph index 120. In an embodiment, application 116 interfaces with servers 106 to access graph entries of graph index 120.

Graph index 120 is an index of graph entries. Graph index 120 is a data structure that can be used to facilitate searches for data. Graph index 120 has a plurality of nodes representing data objects within a dataset. Each node can correspond to a single or subgroup of data objects within the database. Nodes of graph index 120 are also referred to as “graph entries.” As shown in FIG. 1, graph index 120 comprises graph entries 126A-126n. In an embodiment, graph entries 126A-126n form a graph structure. In an embodiment, graph index 120 provides indexing of a database system that is agnostic to the schema of the database system. By using schema-agnostic indexing, systems that leverage graph index 120 can interface with indexes of multiple types of database systems with different schemas.

In an embodiment, graph index 120 stores graph entries 126A-126n as quantized vectors. A quantized vector is generated by compressing a vector or a set of vectors. Vectors can be compressed utilizing a quantization technique such as, but not limited to, scalar quantization or binary quantization. In scalar quantization, float values are compressed into narrower data types, e.g., a vector of 32-bit floats is compressed into a vector of 8 bit integers. In binary quantization, float values are compressed into respective binary bits (i.e., a 32-bit float is compressed into a single bit). By compressing vector data in this manner, such embodiments greatly reduce the storage space consumed by vectors. Quantized vectors can also be leveraged for faster searching.

Search system 104 is a computer-implemented system configured to execute queries to search graph indices of servers 106, e.g., graph index 120. In an embodiment, search system 104 receives one or more queries from computing device 102. As shown in FIG. 1, search system 104 comprises a filter determiner 108, a strategy selector 110, and a result searcher 112, each of which are implemented as hardware, software, and/or a combination of hardware or software.

Filter determiner 108 is configured to determine filters of a query. Filter determiner 108 can determine a filter criterion of a query based on the query, metadata of the query, files of a database being queried, metadata files of a database being queried, a policy of a graph index, and/or other information related to the database and/or the query. For instance, in an embodiment, filter determiner 108 evaluates index policy 124 of graph index 120 to determine filter criteria specified by index policy 124. In another embodiment, filter determiner 108 evaluates file metadata 130 to determine filter criteria.

Strategy selector 110 is configured to select a search strategy to be utilized for satisfying the query. In embodiments, strategy selector 110 determines which search strategy to utilize based on filters determined by filter determiner 108. In an embodiment, strategy selector 110 generates a query plan for executing in order to satisfy the query. Strategy selector 110 can generate multiple query plans and select a query plan from the multiple query plans.

Result searcher 112 performs a search utilizing the search strategy selected by strategy selector 110. In embodiments, result searcher 112 executes the search strategy. Alternatively, result searcher 112 can cause an external service or computing device to perform the search strategy. For instance, in an embodiment, result searcher 112 is configured to execute graph-based search strategies by traversing graph index 120 and cause an external computing device, not shown in FIG. 1, to perform an alternative strategy. Result searcher 112 can perform post-processing steps on results of executing a search strategy. In embodiments, result searcher 112 provides the search result as a response to the query.

In some implementations, result searcher 112 utilizes an iterative post-filtering to enhance the accuracy of search results. An iterative post-filtering process iteratively fetches the next of closest items until the desired number of results is met. In an implementation, iterative post-filtering is performed without compromising on speed or precision. Iterative post-filtering can maintain high relevance and reduce latency in locating search results for search queries. In some embodiments, a graph-index-based search is used. An example iterative post processing strategy utilizing a graph-index-based search query includes a query plan where: 1) an approximate nearest neighbor search is executed on a complete index without applying filters at first; 2) a pool of the nearest neighbors are retrieved and the filter is applied to the results, the results matching the criteria are retained; and 3) the documents to be searched are iterated through in order of similarity until a requested number of documents matching the filters are found. By using this three-step query plan, the graph-index-based search is a connected search. However, this search could return items that get thrown out in post-filtering, e.g., for failing to satisfy filtering criteria. For instance, if filter criteria is highly selective, many of the top neighbors are discarded. In this context, in some situations, result searcher 112 has to search through more candidates to find valid results, expending extra compute resources and performing extra distance comparisons.

To address issues of iterative post-filtering search strategies, embodiments of result searcher 112 implement filter-aware search techniques based on the operation of filter determiner 108 and strategy selector 110 described herein. This filter-aware search method enables result searcher 112 to dynamically adjust how search results are identified for a query. Result searcher 112 can prioritize checking relevant data first based on filter criterion identified by filter determiner 108. By dynamically adjusting search methods in this manner, result searcher 112 provides a user fast, accurate results even when searching through many items (e.g., thousands, millions, or even greater number of documents) with complex filters (e.g., multiple filters).

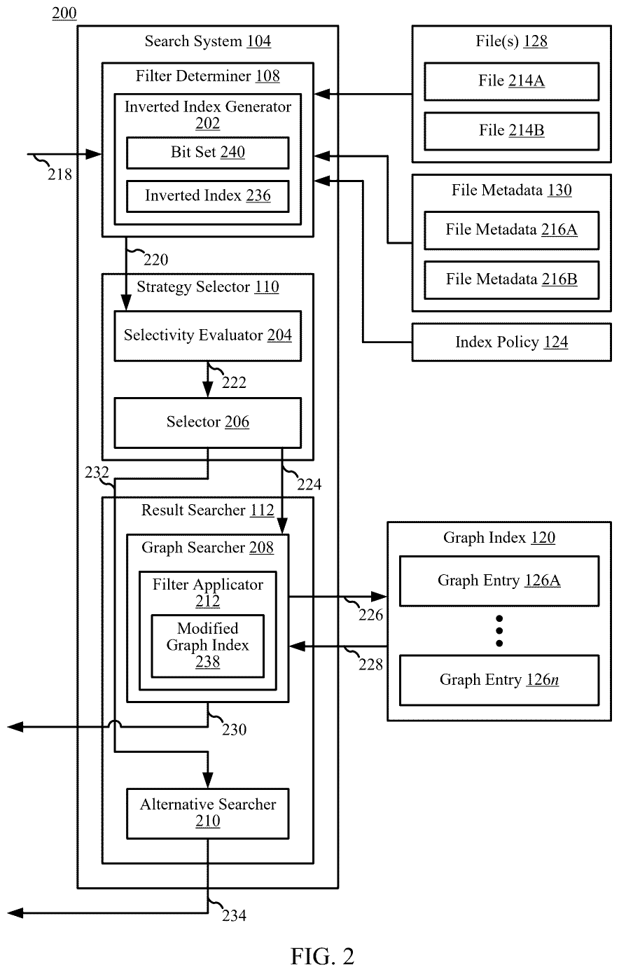

Embodiments of search system 104 can operate in various ways to implement filter-aware searching. For example, FIG. 2 shows a block diagram of a system 200 including search system 104 (including filter determiner 108, strategy selector 110, and result searcher 112) of FIG. 1, in accordance with an example embodiment. As shown in FIG. 2, system 200 also includes graph index 120 (including graph entries 126A-126n), index policy 124, files 128, and file metadata 130, as described with respect to FIG. 1. Files 128 include at least file 214A and file 214B, which are any type of file of a database system. File metadata 130 includes file metadata 216A and file metadata 216B. File metadata 216A describes attributes of file 214A and file metadata 216B describes attributes of file 214B. As further shown in FIG. 2, filter determiner 108 includes an inverted index generator 202, strategy selector 110 includes a selectivity evaluator 204 and a selector 206, and result searcher 112 includes a graph searcher 208 (including a filter applicator 212) and an alternative searcher 210. Inverted index generator 202, selectivity evaluator 204, selector 206, graph searcher 208, alternative searcher 210, and filter applicator 212 are computer-implemented subservices or subcomponents of their respective subservices/subcomponents of search system 104. In some embodiments, components and subcomponents of search system 104 are implemented in a single computing device or system. Alternatively, one or more components or subcomponents of search system 104 are implemented by a separate computing device or system. For instance, in an embodiment, either graph searcher 208 or alternative searcher 210 are implemented as a separate device or system than search system 104. In another example, filter determiner 108 and strategy selector 110 are integrated as a strategy determining system separate from result searcher 112.

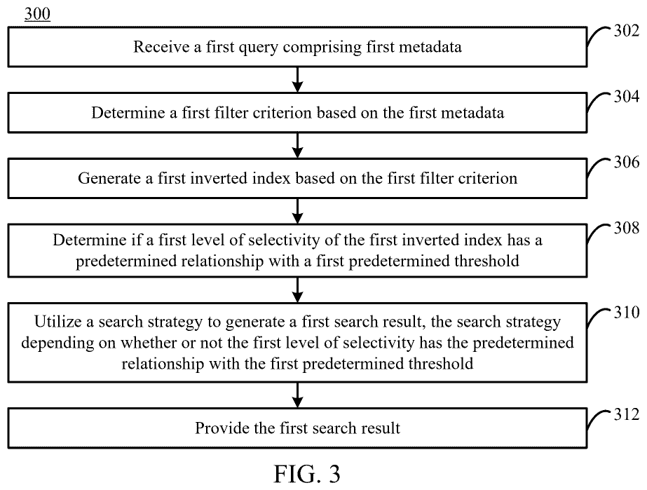

To better understand the operation of search system 104 of system 200, FIG. 2 is described with respect to FIG. 3. FIG. 3 shows a flowchart 300 of a process for filter-aware graph searching, in accordance with an example embodiment. In an embodiment, search system 104 of FIG. 2 operates according to one or more steps of flowchart 300. Note that not all steps of flowchart 300 need be performed in all embodiments. Further structural and operational embodiments will be apparent to persons skilled in the relevant art(s) based on the following descriptions of FIGS. 2 and 3.

Flowchart 300 begins with step 302. In step 302, a first query comprising first metadata is received. For example, query 218 is received by filter determiner 108. In an embodiment, query 218 comprises query metadata. Query metadata is any type of metadata associated with query 218. For instance, query metadata can include, but is not limited to, the query, a type of the query, a language of the query, an author of the query, a size of the query, a query vector corresponding to the query, the creation date of the query, the originating device of the query, and/or other attributes associated with the query. A query can be formatted in various ways.

To better understand the operation of search system 104 with respect to flowchart 300, a non-limiting example is described with respect to the following example query, Query Q:

QUERY Q

| | |
|---|---|
| 1: | SELECT TOP 10 c.id, VectorDistance |
| | (c.embedding, @vectorEmbedding) AS |
| 2: | similarityScore |
| 3: | FROM c |
| 4: | Where c.country = “JP” AND c.year < “2004” |
| 5: | ORDER BY VectorDistance |
| | (c.embedding, @vectorembedding, false) |

Query Q is a query for the top 10 similar pictures taken before 2004 in Japan. In line 1 of Query Q, the query to be executed is shown.

In step 304, a first filter criterion is determined based on the first metadata. For example, filter determiner 108 of FIG. 2 determines a first filter criterion based on metadata of query 218. Filter determiner 108 can determine filter criteria in various ways. For instance, filter determiner 108 can determine filter criteria based on: query 218, query metadata, files 128; file metadata 130; index policy 124; vector embeddings corresponding to query 218, query metadata, files 128, file metadata 130, and/or index policy 124; and/or other information related to the query and/or files to be searched or considered for searching. With continued reference to the non-limiting example described with respect to Query Q, in line 4 of Query Q, two filters to be applied to the query are introduced. A first filter specifies the country the pictures were taken in as Japan and the second query specifies the year the pictures were taken to be before 2004.

In step 306, a first inverted index is generated based on the first filter criterion. For example, inverted index generator 202 generates inverted index 236 based on filter criterion determined in step 304. In an embodiment, inverted index generator 202 generates inverted index 236 utilizing graph index 120. Inverted index 236 is a data structure that stores a mapping of terms, numbers, and/or other content to their location in files of files 128. In some embodiments, and as further described with respect to FIG. 5, as well as elsewhere herein, inverted index generator 202 generates bit set 240 to generate inverted index 236. Inverted index 236 can be utilized to determine a selectivity of filters to be used in searching a graph index 120. For instance, if the content of an inverted index, which is representative of filter criteria determined in step 304, points to a relatively high number of files of files 128, inverted index 236 can indicate the set of filters have a low selectivity, e.g., there are many candidates for a search. If the content of the inverted index points to relatively low number of files of files 128, or if there is relatively little overlap between respective files pointed by the content of inverted index 236, inverted index 236 can indicate the set of filters have a high selectivity, e.g., there are few candidates for a search. In an embodiment, filter determiner 108 provides inverted index 236 and/or other information related to the query as index information 220 to selectivity evaluator 204.

Consider the non-limiting example described with respect to Query Q. Further consider file 214A is a picture taken in Japan in 2003 and file 214B is a picture taken in Canada in 2002. In this context, inverted index 236 could be represented as Index INV:

Index INV

| | |
|---|---|
| Before 2004 | File 214A, File 214B |
| Country is Japan | File 214A |

As shown in Index INV, files 214A and 214B both satisfy the “Before 2004” filter criterion and file 214A satisfies the “Country is Japan” criterion determined in step 304.

In step 308, a determination of whether a first level of selectivity of the first inverted index has a predetermined relationship with a first predetermined threshold is made. For example, selectivity evaluator 204 of FIG. 2 determines whether a level of selectivity of inverted index 236 has a predetermined relationship with a predetermined threshold. Depending on the information, selectivity evaluator 204 determines whether or not result searcher 112 is to use a graph-index-based search strategy or an alternative search strategy. For example, in some embodiments, highly selective filters have a level of selectivity that is higher than a predetermined selectivity threshold. In this context, many nearest neighbors can be discarded and a search strategy has to search through more candidates to find enough valid search results. This can waste computational resources as extra distance comparisons are performed. In order to reduce or avoid this computational resource waste, embodiments of the present disclosure evaluate the level of selectivity of filter criteria of a query based on inverted index 236. If the level of selectivity satisfies the predetermined threshold (e.g., the level of selectivity is below the threshold), selectivity evaluator 204 transmits a selectivity signal 222 to selector 206 causing selector 206 to select a graph-index-based search strategy. In this context, selector 206 transmits search instructions 224 to graph searcher 208. If the level of selectivity fails to satisfy the predetermined threshold (e.g., the level of selectivity is above the threshold), selectivity evaluator 204 transmits a selectivity signal 222 to selector 206 causing selector 206 to select an alternative search strategy. In this context, selector 206 transmits search instructions 232 to alternative searcher 210. By adaptively determining whether to use the graph-index-based search strategy or an alternative search strategy, strategy selector 110 reduces the average computational costs in responding to queries.

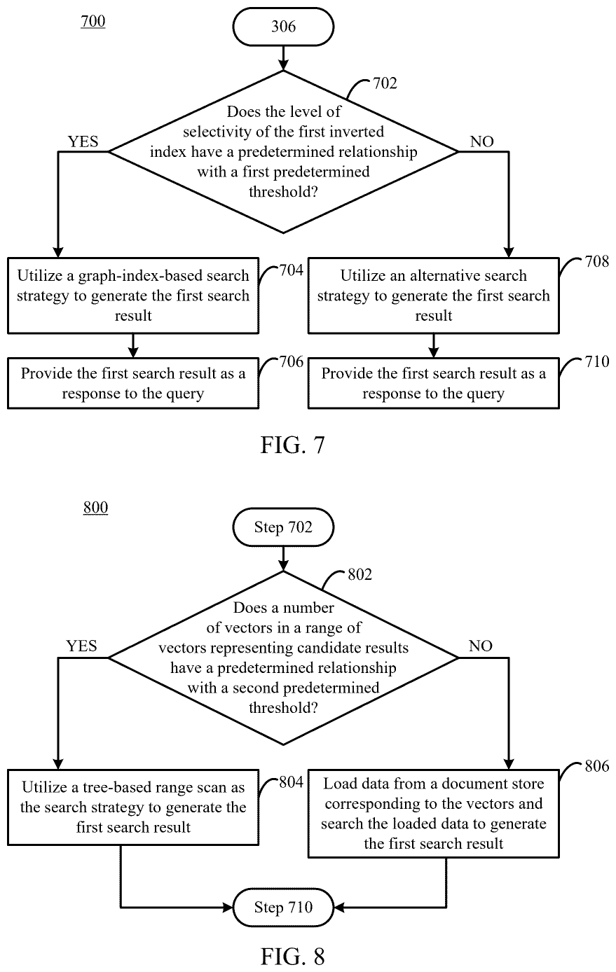

In step 310, a search strategy is utilized to generate a first search result, the search strategy depending on whether or not the first level of selectivity has the predetermined relationship with the first predetermined threshold. For example, result searcher 112 utilizes a search strategy to generate a search result 230 or 234. The search strategy utilized by result searcher 112 depends on whether or not the level of selectivity of inverted index 236 satisfies the predetermined threshold. For example, if the level of selectivity of inverted index, is below a threshold, graph searcher 208 of result searcher 112 receives search instructions 224 and searches graph index 120 for a result. As shown in FIG. 2, graph searcher 208 performs a search operation on graph index 120 to locate a search result and receives the result as search result 228. In some embodiments, and as described elsewhere herein, graph searcher 208 searches a modified version of graph index 120, such as modified graph index 238. In this example, if the level of selectivity of inverted index 236 is above a threshold, alternative searcher 210 of result searcher 112 receives search instructions 232 and utilizes an alternative search strategy to locate a search result 230. Further examples of graph-index-based search strategies and alternative search strategies are described with respect to FIG. 7, as well as elsewhere herein.

In step 312, the first search result is provided. For example, result searcher 112 provides either search result 230 or search result 234 as a response to query 218.

Thus, an example embodiment of a system implementing filter aware graph search techniques has been described with respect to FIGS. 2 and 3. By implementing filter aware graph searching in this manner, search system 104 can select a search strategy from a set of search strategies that has a relatively high likelihood of improving search performance compared to the other search strategies. Thus, the compute resources expended in searching for a search result that satisfies the received query are reduced. Furthermore, the latency in returning a result to a query is reduced. By reducing latency in satisfying queries in this manner, systems that rely on search systems for performing various functions can be improved. For example, in a cyber-security implementation, a security system provides a search query to search system 104 for identifying information in a database for use in mitigating vulnerabilities of a networked computing system. By reducing the latency in satisfying the search query, search system 104 reduces the time the vulnerability remains exposed to malicious entities, such as hackers, thereby improving the security of the networked computing system.

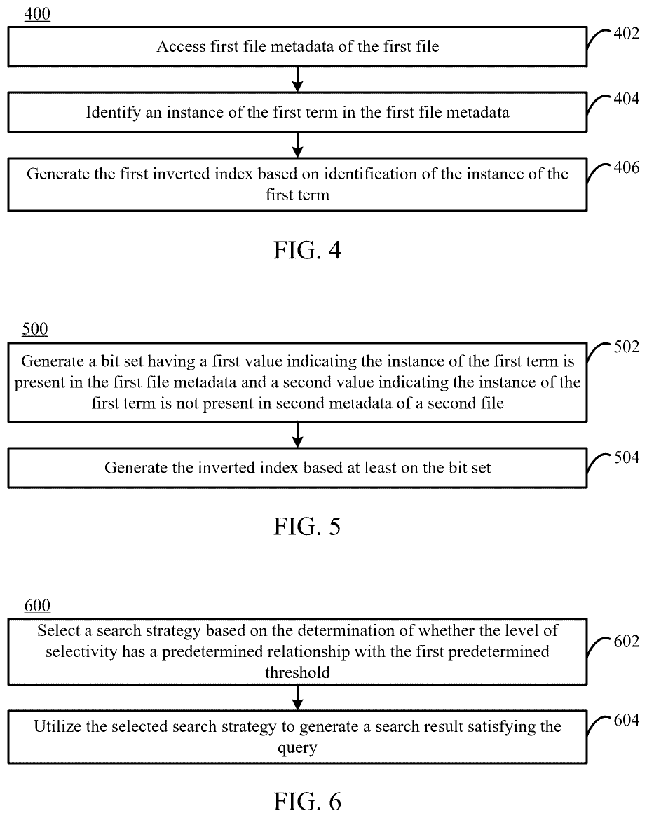

Inverted indexes can be generated in various ways, in embodiments. For example, an inverted index can be generated based on the metadata of the query and file metadata. Inverted index generator 202 can operate in various ways to generate an inverted index based on file metadata. For instance, FIG. 4 shows a flowchart 400 of a process for generating an inverted index, in accordance with an example embodiment. In an embodiment, inverted index generator 202 of FIG. 2 operates according to one or more steps of flowchart 400. Note that not all steps of flowchart 400 need be performed in all embodiments. Further structural and operational embodiments will be apparent to persons skilled in the relevant art(s) based on the following description of FIG. 4.

Flowchart 400 begins with step 402. In step 402, first file metadata of the first file is accessed. For instance, an example of file determiner 108 of FIG. 2 accesses file metadata 216A of file 214A and/or file metadata 216B of file 214B.

In step 404, an instance of a first term is identified in the first file metadata. For example, suppose inverted index generator 202 of FIG. 2 identifies a term in file metadata 216A. In this example, the term matches a term in metadata of query 218. By identifying matching terms between metadata of query 218 and file metadata, inverted index generator 202 determines candidate files for searching for a result that satisfies query 218. As a non-limiting example described with respect to Query Q, suppose metadata of query 218 indicated that query 218 is to be filtered based on results from the country Japan. In this example, inverted index generator 202 identifies which file metadata of file metadata 130 also have the country Japan within.

In embodiments, inverted index generator 202 can also identify other attributes of a corresponding file within file metadata. For instance, inverted index generator 202 of FIG. 2 can identify if a number falling within a range, a file size within a range, a file size matching a predetermined number, a creation date satisfying a criterion, a permission to access the corresponding file, whether or not the file is hidden, and/or other properties of the file corresponding to the file metadata. For instance, with continued reference to Query Q, further suppose metadata of query 218 indicated that query 218 is to be filtered based on a creation date prior to 2004. In this example, inverted index generator 202 identifies which file metadata of file metadata 130 indicates the creation date is prior to the year 2004.

In step 406, the first inverted index is generated based on identification of the instance of the first term. For example, inverted index generator 202 of FIG. 2 generates inverted index 236 based on identification of the instance of the first term in step 200. For example, inverted index generator 202 generates an inverted index 236 that can be utilized to determine which files of files 128 satisfy filter criteria of query 218.

Inverted index generator 202 can generate inverted indexes in various ways, in embodiments. As another example, inverted index generator 202 generates a bit set utilized in generating inverted indexes. For example, FIG. 5 shows a flowchart of a process for generating an inverted index utilizing a bit set, in accordance with an example embodiment. In an embodiment, inverted index generator 202 of FIG. 2 operates according to one or more steps of flowchart 500. In an embodiment, one or more steps of flowchart 500 are further examples of step 406 of flowchart 400 of FIG. 4. Note that not all steps of flowchart 500 need be performed in all embodiments. Further structural and operational embodiments will be apparent to persons skilled in the relevant art(s) based on the following description of FIG. 5.

Flowchart 500 begins with step 502. In step 502, a bit set is generated, the bit set having a first value indicating an instance of the first term is present in the first metadata and a second value indicating the instance of the first term is not present in second metadata of a second file. For example, inverted index generator 202 generates bit set 240. Bit set 240 has one or more values. The values represent whether or not a file satisfies a corresponding filter criterion. In an embodiment, the values are determined based on file metadata, such as file metadata 216A and 216B. For instance, suppose query 218 or metadata thereof has a first term. In this example, bit set 240 has a first value indicating the term is present in metadata 216A and a second value indicating the term is not present in metadata 216B. In an implementation, inverted index generator 202 utilizes an underlying tree-based data structure of graph index 120 to generate bit set 240. Bit set 240 can be a string of bits, a bit matrix, a bit map, a table, or another type of representation of bits. For instance, in an example described with respect to Query Q, inverted index generator 202 utilizes file metadata 130 to generate bit set 240 as the following bit matrix, Bit Matrix B:

$$\begin{matrix}1 & 1 \\ 0 & 1 \\ ⋯ & ⋯ \\ 0 & 0\end{matrix}$$

The rows of Bit Matrix B correspond to files of files 128 and the columns of Bit Matrix B correspond to filter criterion of query 218. In Bit Matrix B, the first row corresponds to file 214A, the second row corresponds to file 214B, and the nth row corresponds to a file 214n, not shown in FIG. 2 for brevity, and the first column corresponds to the country filter of Query Q and the second column corresponds to the year filter of Query Q. Each entry of Bit Matrix B comprises a bit indicating of whether or not the file of the corresponding row satisfies the filter of the corresponding column. As shown in Bit Matrix B, file 214A satisfies both filter criteria, file 214n satisfies the year filter criterion, and filter 214n does not satisfy either filter criteria.

In step 504, the inverted index is generated based at least on the bit set. For instance, inverted index generator 202 generates inverted index 236 based at least on bit set 240. As an example, inverted index generator 202 generates a table with a first column corresponding to filter criteria of filters determined by filter determiner 108 and utilizes bit set 240 to identify which graph entries of graph index 120 should be mapped to the filter criteria. As a further example further described with respect to Query Q and Bit Matrix B, inverted index generator generates Index INV by utilizing Bit Matrix B to determine which filters in the first column of Index INV should be mapped to files of files 128.

Strategy selector 110 and result searcher 112 can operate in various ways to select and execute search strategies. For example, FIG. 6 shows a flowchart 600 of a process for selecting and using a search strategy based on selectivity, in accordance with an example embodiment. In an embodiment, search system 104 of FIG. 2 operates according to one or more steps of flowchart 600. Note that not all steps of flowchart 600 need be performed in all embodiments. Further structural and operational embodiments will be apparent to persons skilled in the relevant art(s) based on the following description of FIG. 6.

Flowchart 600 begins with step 602, which is a further sub-step of step 310 of flowchart 300 of FIG. 3. In step 602, a search strategy is selected based on the determination of whether the level of selectivity has a predetermined relationship with the predetermined threshold. For example, selector 206 selects a search strategy based on the determination of whether the level of selectivity of inverted index 236 has a predetermined relationship with a predetermined threshold. For instance, if a level of selectivity of inverted index 236 is above a threshold, an embodiment of selectivity evaluator 204 determines the filters of inverted index 236 are highly selective and selectivity signal 222 causes selector 206 to determine to utilize an alternative search strategy to generate a search result for query 218. In an embodiment, if the level of selectivity of selectivity of inverted index 236 is below a threshold, selectivity evaluator 204 determines the filters of inverted index 236 are not highly selective and selectivity signal 222 causes selector 206 to determine to utilize a graph-index-based search strategy to generate a search result for query 218.

Flowchart 600 continues with step 604, which is a further sub-step of step 310 of flowchart 300 of FIG. 3. In step 604, the selected search strategy is utilized to generate a search result satisfying the query. For example, result searcher 112 utilizes the selected search strategy to generate a search result satisfying query 218. As shown in FIG. 2, if a graph-index-based search strategy is selected in step 602, selector 206 transmits instructions 224 causing graph searcher 208 to search graph index 120 and generate a search result 230 satisfying query 218. As also shown in FIG. 2, if an alternative search strategy is selected in step 602, selector 206 transmits instructions 232 causing alternative searcher 210 to utilize an alternative search strategy to generate a search result 234 satisfying query 218.

As described herein, search strategies can be selected and executed in various ways, in embodiments. For instance, a determination of whether to use a graph-index-based search strategy or an alternative search strategy can be made and the determined search strategy can be utilized to generate a search result. Search system 104 can determine which strategy to use and utilize the determined strategy in various ways. For instance, search system 104 can provide a filter aware search system that utilizes graph-index-based searching or one or more alternative types of searching in order to satisfy queries. In some implementations, a cost model is utilized to determine the type of search that search system 104 is to use. For instance, strategy selector 110 can utilize a cost model to determine search system 104 is to examine M candidates on average. With a filter that passes a fraction f, search system 104 examines M/f candidates to identify enough valid results. In some implementations, the distribution of filtered points and distances to the filtered points can impact the actual number of candidates examined. For instance, if the filter-correlated vectors happen to cluster in certain graph regions, the search might find them faster than the 1/f worst case. Conversely, if the filter is uncorrelated with vector proximity, the search will encounter many non-matching neighbors and have to keep expanding. As filters become more selective, the graph-index-based search slows down (e.g., non-linearly). There can be a point where the overhead outstrips the benefit of using the graph index.

Search system 104 can operate in various ways to adapt search strategies in order to address the point where the overhead of using a graph index outstrips its benefit. For example, FIG. 7 shows a flowchart 700 of a process for selecting and using a graph-index-based search strategy or an alternative search strategy, in accordance with an example embodiment. In an embodiment, search system 104 of FIG. 2 operates according to one or more steps of flowchart 700. Note that not all steps of flowchart 700 need be performed in all embodiments. Further structural and operational embodiments will be apparent to persons skilled in the relevant art(s) based on the following description of FIG. 7.

Flowchart 700 begins with step 306 of flowchart 300 of FIG. 3 and continues with step 702. In an embodiment, step 702 is a further example of step 308 of flowchart 300. In step 702, a determination of whether or not the level of selectivity of the first inverted index has a predetermined relationship with a first predetermined threshold is made. For example, selectivity evaluator 204 of FIG. 2 determines whether or not the level of selectivity of inverted index 236 has a predetermined relationship with a first predetermined threshold. If the first index does have the predetermined relationship, flowchart 700 continues to step 704. If not, flowchart 700 continues to step 708.

In some implementations, the first predetermined threshold is a threshold where an exact search with filters has a lower computational cost than a graph-index-based search using the filter-constrained graph index (e.g., modified graph index 238). This threshold can be determined based on data dimensionality, graph parameters, index size, and/or other factors. The cost of navigating the graph under filters can range from near baseline to substantially higher. For example, if a level of selectivity of the filter is below the predetermined threshold, flowchart 700 continues to step 704. However, if the level of selectivity of the filter is above the predetermined threshold, the computational cost of utilizing the graph-index-based search is greater than the computational cost of an alternative search strategy and flowchart 700 continues to step 708. In an embodiment, the predetermined threshold represents a level of selectivity where a likelihood of the computational cost of utilizing the graph-index-based search being greater than the computational cost of the alternative search strategy satisfies a likeliness threshold. By dynamically selecting a search strategy based on filter-aware selectivity analysis in this manner, embodiments of the present disclosure are able to reduce latency and compute resources expended in searching for query results.

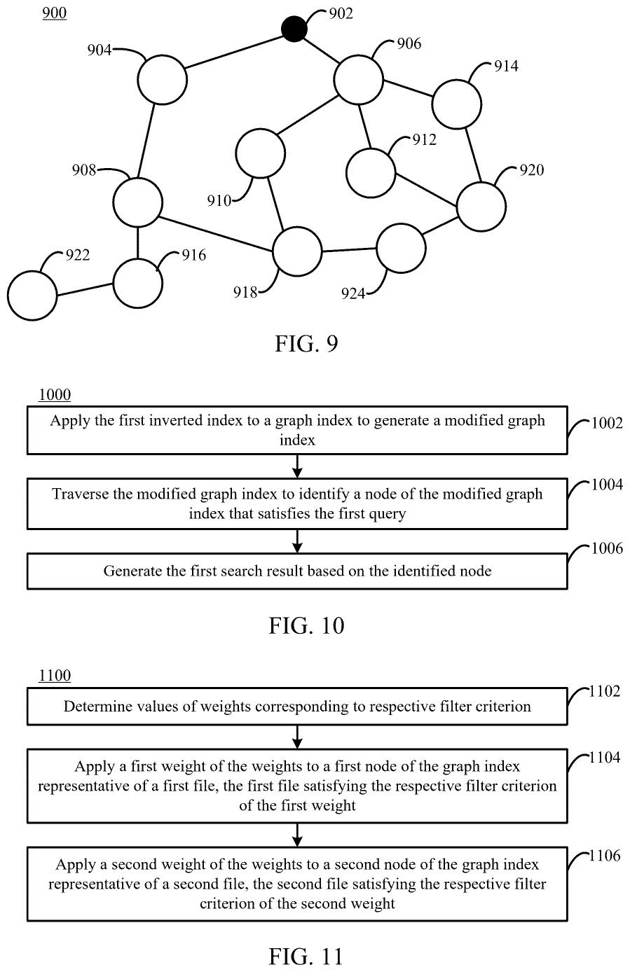

In step 704, a graph-index-based search strategy is utilized to generate the first search result. For example, graph searcher 208 utilizes a graph-index-based search strategy to generate search result 230. In an embodiment, graph searcher 208 traverses graph index 120 to locate a search result 228 satisfying query 218. Graph searcher 208 can traverse graph index 120 in various ways, in embodiments. For instance, graph searcher 208 can greedily traverse graph index 120 to determine which node of graph index 120 to traverse to. Further details regarding graph indexes and traversal thereof are described with respect to FIGS. 9 and 10, as well as elsewhere herein. In some embodiments, graph searcher 208 utilizes filter applicator 212 to modify graph index 120, resulting in modified graph index 238, and traverses modified graph index 238 to generate search result 230. Further details regarding modifying graph index 120 are described with respect to FIGS. 10 and 11, as well as elsewhere herein.

In step 706, the first search result is provided as a response to the query. For example, graph searcher 208 provides the search result from traversing graph index 120 or modified graph index 238 as search result 230 as a response to query 218. In an embodiment, graph searcher 208 performs one or more post-processing steps on the search result to generate search result 230. Alternatively, graph searcher 208 provides the traversal result directly as search result 230.

In step 708, an alternative search strategy is utilized to generate the first search result. For example, alternative searcher 210 utilizes an alternative search strategy to generate search result 234. Alternative searcher 210 can perform various alternative strategies, including, but not limited to, utilizing a tree-based range scan on quantized vector data, loading data from a document store and searching the loaded data, performing keyword searching of data, performing a regular expression search on data, and/or other types of search strategies other than the graph-index-based search strategy utilized by graph searcher 208. Example tree-based search strategies and document loading search strategies are described with respect to FIG. 8, as well as elsewhere herein.

In step 710, the first search result is provided as a response to the query. For example, alternative searcher 210 provides the search result from performing an alternative search strategy as search result 234 as a response to query 218. In an embodiment, alternative searcher 210 performs one or more post-processing steps on the search result to generate search result 234.

As described herein, if the first index does not have a predetermined relationship with a predetermined threshold, an alternative search strategy is used. In some implementations, multiple alternative search strategies can be selected from. In this scenario, strategy selector 110 can operate in various ways to select an alternative search strategy. For example, FIG. 8 shows a flowchart 800 of a process for selecting and using an alternative search strategy, in accordance with an example embodiment. In an embodiment, strategy selector 110 of FIG. 2 operates according to one or more steps of flowchart 800. Note that not all steps of flowchart 800 need be performed in all embodiments. Further structural and operational embodiments will be apparent to persons skilled in the relevant art(s) based on the following description of FIG. 8.

Flowchart 800 begins with step 702 of flowchart 702. In this context, the level of selectivity is determined to not have the predetermined relationship with the predetermined threshold and flow continues to step 802. In step 802, a determination of whether or not a number of vectors in a range of vectors representing candidate results has a predetermined relationship with a second predetermined threshold is made. For example, in an embodiment, selectivity evaluator 204 determines whether or not a number of vectors in a range of vectors representing candidate results has a predetermined relationship with a second predetermined threshold is made and provides a result of the determination in selectivity signal 222. In an embodiment, the second predetermined threshold is referred to as a “range threshold.” If the number of vectors does have the predetermined relationship with the second predetermined threshold, flowchart 800 continues to step 804. Otherwise, flowchart 800 continues to step 806. In an embodiment, selectivity evaluator 204 makes the determination subsequent to determining the level of selectivity of inverted index 236 is below a predetermined range threshold. By selecting an alternative search strategy in this manner, embodiments of strategy selector 110 can further improve compute resource utilization in generating search results.

The second predetermined threshold can be represented in various ways, in embodiments. For example, if files of files 128 to be searched for satisfying the query are spread across a range in vector space at or above a range threshold, flowchart 800 continues to step 806; otherwise, flowchart 800 continues to step 804. In another example, if a number of candidates is below a candidate threshold, flowchart 800 continues to step 806; otherwise, flowchart 800 continues to step 804. In another example, flowchart 800 continues to step 806 if the files are spread across a range at or above the range threshold and if the number of candidates is below a candidate threshold; otherwise, flowchart 800 continues to step 804.

In step 804, a tree-based range scan is utilized as the search strategy to generate the first search result. For example, selector 206 receives selectivity signal 222 indicating the number of vectors in the range of vectors has the predetermined relationship with the second predetermined threshold, selects a tree-based range scan, and transmits instructions 232 causing alternative searcher 210 to utilize the tree-based range scan to generate search result 234. A range scan is an operation for retrieving elements that fall within a specified range of values. A tree-based range scan retrieves elements from a tree-based data structure. A tree-based data structure, also referred to as a search tree, is a hierarchical data structure designed for searching, inserting, and deleting elements. A tree-based data structure can maintain sorted data and enable quick lookups of the data. A tree-based data structure has a root node and multiple other nodes. Nodes of a tree-based data structure, except for the root node, have a single parent node. Each node of a tree-based data structure can have no children nodes, one children nodes, or multiple children nodes. An example of a tree-based data structure includes, but is not limited to, a binary search tree, a B-tree, a BW-tree, and/or other types of search trees. A B-tree isa self-balancing tree data structure that maintains sorted data and allows searches, sequential access, insertions, and deletions in logarithmic time. The B-tree generalizes the binary search tree, allowing for nodes with more than two children. A BW-tree utilizes a latch-free approach that exploits processor caches of multi-core chips. In a non-limiting example, a heuristic path leverages quantized vectors from a tree-based data structure. For instance, a faster tree-based range scan can leverage a BW-tree that stores quantized vectors rather than loading vectors individually from a document store if the documents are in a range below the second predetermined threshold (as determined in step 802). By leveraging quantized vectors, such systems can reduce latency in generating questions.

Subsequent to step 804, flowchart 800 ends with step 710 of flowchart 700 of FIG. 7.

In step 806, data is loaded from a document store corresponding to the vectors and the loaded data is searched to generate the first search result. For instance, selector 206 receives selectivity signal 222 indicating the number of vectors in the range of vectors fails to have the predetermined relationship with the second predetermined threshold, selects a document load strategy, and transmits instructions 232 causing alternative searcher 210 to load data from a document store (e.g., data store 118) and search the loaded data to generate search result 234. For example, if the query potentially matches documents scattered across a range greater than the second predetermined threshold, as determined in step 802, but with a number of candidates that fails to satisfy a candidate threshold, individual data files are loaded from a document store. This can compute resources that would be expended on a large range quantized vector scan.

Subsequent to step 806, flowchart 800 ends with step 710 of flowchart 700 of FIG. 7.

Embodiments of graph indexes can be constructed in various ways. For example, FIG. 9 shows a block diagram of a graph index 900 (also referred to as “graph 900” herein), in accordance with an example embodiment. Graph 900 is an example of a graph index, such as graph index 120 of FIG. 1. As shown in FIG. 9, graph 900 includes a start node 902 and a plurality of nodes 904-924. Start node 902 and nodes 904-924 are collectively referred to as “nodes 902-924” herein. In graph 900, relationships between nodes 902-924 are represented as edges. In embodiments, edges are generated randomly, based on similarities between nodes, or a combination thereof. In an embodiment, nodes 902-924 represent files in a file system, such as a database. For instance, nodes 902-924 represent respective files of files 128. In an example, a graph generator generates graph 900 utilizing semantic similarities between nodes. Semantic similarities can be determined utilizing an embedding model, such as a large language model or other type of generative artificial intelligence model. While graph 900 has a designated start node 902, other implementations of graph indexes can have multiple designated start nodes or no designated start nodes. In an implementation where multiple designated start nodes are utilized, traversal of the graph can begin at an arbitrary start node or a start node that is semantically related to a query. In an implementation where no designated start node is utilized, traversal of the graph can begin at an arbitrary, random, or pseudo-random node.

To better understand graph searcher 208 utilizing graph 900, FIGS. 2 and 9 are described with respect to FIG. 10. FIG. 10 shows a flowchart 1000 of a process for using a graph-index-based search strategy, in accordance with an example embodiment. In an embodiment, inverted index generator 202 and/or graph searcher 208 of FIG. 2 operate according to one or more steps of flowchart 1000. Note that not all steps of flowchart 1000 need be performed in all embodiments. Further structural and operational embodiments will be apparent to persons skilled in the relevant art(s) based on the following descriptions of FIGS. 9 and 10 with respect to FIG. 2.

Flowchart 1000 begins with step 1002, which is a further embodiment of step 306 of flowchart 300 of FIG. 3. In step 1002, the first inverted index is applied to a graph index to generate a modified graph index. For example, in some embodiments, inverted index generator 202 applies inverted index 236 to graph index 120 to generate modified graph index 238. In an embodiment, inverted index generator 202 applies weights, notations, or other modifications to nodes of graph index 120 representative of files indicated in inverted index generator 202. Further embodiments of applying weights to graph index 120 are described with respect to FIG. 11, as well as elsewhere herein. In an embodiment, inverted index generator 202 modifies graph 900 of FIG. 9 to generate modified graph index 238. Inverted index generator 202 can modify graph 900 by applying a weight to one or more nodes of nodes 902-924, adjusting a length of an edge between two nodes of nodes 902-924, adding or removing edges between two nodes of nodes 902-924, and/or otherwise modifying graph 900 to generate modified graph index 238.

While step 1002 of flowchart 1000 is described as a further embodiment of step 306, in some alternative embodiments, the modified graph index is generated after the determination made in step 308 or step 702. For instance, if strategy selector 110 determines a graph-index-based search strategy is to be utilized, it can cause filter applicator 212 to apply the inverted index 236 to graph index 120 to generate modified graph index 238, as shown in FIG. 2. With reference to graph 900 of FIG. 9, suppose graph 900 is an example of graph index 120. In this context, filter applicator 212 applies inverted index 236 to graph 900 to generate modified graph index 238. Filter applicator 212 can modify graph 900 by decreasing the length of edges between nodes, increasing the length of an edge, applying a weight to a node, removing an edge, removing a node from consideration, adding an edge, and/or otherwise modifying graph 900.

Flowchart 1000 continues with steps 1004 and 1006, which are further embodiments of step 704 of flowchart 700. In step 1004, the modified graph index is traversed to identify a node of the modified graph index that satisfies the first query. For example, graph searcher 208 traverses modified graph index 238 to identify a node of modified graph index 238 that satisfies the first query. For instance, suppose node 918 of graph 900 corresponds to a search result that satisfies query 218. In order to identify node 918, in an embodiment, graph searcher 208 starts traversal of graph 900 (modified as described herein) at start node 902 and travels to a next node of the modified version of graph 900. Graph searcher 208 continues traversing graph 900 until it reaches a node that satisfies query 218, i.e., node 918 in this example. In an embodiment, graph searcher 208 greedily traverses graph 900 by traversing to the next node that has a level of semantic similarity to query 218 that is higher than respective levels of semantic similarity to query 218 of other nodes a current node is connected to. For example, suppose graph searcher 208 is on node 902 and has to determine to traverse to node 904 or node 906 of graph 900. In this example, graph searcher 208 determines a level of semantic similarity between node 906 and query 218 is higher than respective levels of semantic similarity to query 218 of nodes 902 and 904, and graph searcher 208 traverses to node 906. At node 906, graph searcher 208 determines a level of semantic similarity between query 218 and node 910 is higher than respective levels of semantic similarity to query 218 of nodes 906, 912, and 914, and traverses to node 910. At node 9010, graph searcher 208 determines a level of semantic similarity between query 218 and node 918 is higher than the level of semantic similarity between query 218 and node 910, and traverses to node 918. At node 918, graph searcher 208 determines node 918 corresponds to the search result based on a level of semantic similarity between query 218 and node 918 being higher than respective levels of semantic similarity to query 218 of nodes 908 and 924.

As described herein with respect to flowchart 1000, in some embodiments, the graph traversed by graph searcher 208 is a modified version of graph 900. Modifying graph 900 can result in graph searcher 208 selecting a different node when traversing graph 900 to satisfy query 218 than would otherwise have been selected if graph 900 was not modified. For instance, in an embodiment, graph 900 is modified by removing nodes 912, 920, and 924 from the modified version of graph 900 for use in searching for a result to query 218. In this example, nodes 912, 920, and/or 924 are removed for failing to satisfy filter criteria to be applied to the search query. By removing these nodes, the computational resources expended by graph searcher 208 in traversing graph 900 are reduced, as less comparisons and decisions have to be made. Furthermore, graph searcher 208 is prevented from selecting a node that failed to satisfy filter criteria but may have otherwise been selected as a potential search result. For instance, suppose un-modified versions of nodes 912 and 920 have a level of semantic similarity to query 218 than nodes 910, 914, and 924. In this context, graph searcher 208 could erroneously traverse to node 912 instead of 910 and end at node 920, producing an incorrect result. In another example described further with respect to FIG. 11, graph 900 is modified by applying weights to different nodes to affect how graph searcher 208 traverses graph 900.

In step 1006, the first search result is generated based on the identified node. For example, graph searcher 208 of FIG. 2 generates search result 230 based on the node identified in step 1004. For example, with respect to FIG. 9 and the non-limiting example described herein where graph searcher 208 ends traversal of graph 900 on node 918, graph searcher 208 generates search result 230 based on node 918. In an embodiment, graph searcher 208 accesses a file corresponding to node 918. For example, suppose node 918 corresponds to graph entry 126A and file 214A. In this example, graph searcher 208 accesses file 214A and generates search result 230. Graph searcher 208 can provide the entirety of file 214A as search result 230, a universal resource locator link to a location where file 214A is stored as search result 230, a portion of data of file 214A as search result 230, and/or other data related to file 214A as search result 230. For example, if query 218 is a query for information stored within file 214A, graph searcher 208 can identify the information within file 214A and provide the identified information as search result 230.

As described herein, a modified graph index can be generated for traversing to determine a result of a query. In this manner, weights can be applied to nodes of a graph index based on filter criteria related to the query. Filter applicator 212 of FIG. 2 can operate in various ways to apply weights to a graph index. For example, FIG. 11 shows a flowchart 1100 of a process for applying weights to nodes in a graph index, in accordance with an example embodiment. In an embodiment, filter applicator 212 of FIG. 2 operates according to one or more steps of flowchart 1100. Note that not all steps of flowchart 1100 need be performed in all embodiments. In an embodiment, one or more steps of flowchart 1100 are further embodiments of step 1002 of flowchart 1000 of FIG. 10. Further structural and operational embodiments will be apparent to persons skilled in the relevant art(s) based on the following description of FIG. 11 with respect to FIGS. 2 and 9.

Flowchart 1100 begins with step 1102. In step 1102, values of weights corresponding to respective filter criterion are determined. For example, filter applicator 212 of FIG. 2 determines values of weights corresponding to respective filter criterion. In an embodiment, a value for a weight is determined based on a priority of a filter criterion over another filter criterion. For instance, if a first filter criterion is considered of higher importance than a second filter criterion, the weight value corresponding to the first filter criterion will be set higher than the weight value corresponding to the second filter criterion. Weight values can be in a variety of ranges such as 0 to 1, 0 to 100, 1 to 10, 1 to 100, and/or the like. In another example, weights are binary, either the filter is considered or is not considered in searching. In an example, the highest value of a weight enforces strict adherence to the corresponding filter criterion during traversal of graph index 120. A lowest value is interpreted as ignoring the filter criterion during traversal of graph index 120. In some embodiments, a filter criterion is not considered during traversal of graph index 120 but is applied during post-processing of the search results. Intermediary values of a weight enable adaptive navigation, balancing recall and efficiency based on filter selectivity and data distribution. By adapting navigation in this manner, unnecessary searching in graph index 120 can be reduced.

As described herein, nodes of graph index 120 can be weighted based on filter criterion. In embodiments where multiple filter criteria are utilized, respective filter priority values can be utilized to determine which of the filter criteria are to be considered in the search. If a priority value of a filter is set low enough, the filter criterion is ignored during searching. For instance, if a weight value of a filter criterion is set to “0” in a 0-100 range, the filter criterion is ignored during traversal of graph index 120. In another example, filter criteria with a priority level below a threshold are ignored. For instance, traversal of graph index 120 in some embodiments considers filters with a priority level above a threshold or a predetermined number of filters in prioritized order. For instance, as a non-limiting example, graph searcher 208 traverses graph index 120 by applying the ten filters with the highest level of priority.

In an embodiment, the thresholds for filter priority is adjustable. For instance, the threshold for whether or not a filter is to be considered is adjusted based on available compute resources, the urgency of the query, the user account requesting the query, and/or the like. For instance, if compute resources are constrained the filter priority can be raised such that (e.g., only) the filter criteria with the highest filter priority value is used. In other examples, other techniques can be utilized. In an embodiment, filter priority values are determined based on previous searches. In an embodiment, whether or not a search returned an appropriate response to a query is utilized to modify a filter priority of a filter criterion, e.g., increase if the search was successful or decrease if the search failed.

For example, with respect to the non-limiting example of Query Q, suppose the country filter has a higher level of priority than the creation year filter. In this context, graph index 120 is modified to modified graph index 238 by determining a higher weight value to be applied to nodes that satisfy the country filter than the weight value to be applied to node that satisfy the creation year filter.

In step 1104, a first weight of the weights is applied to a first node of the graph index representative of a first file, the first file satisfying the respective filter criterion of the first weight. For example, filter applicator 212 of FIG. 2 applies a weight corresponding to a first filter criterion to nodes of graph index 120 that are representative of files satisfying the first filter criterion. With reference to the non-limiting example of Query Q, filter applicator 212 applies a first weight value to nodes that satisfy the country filter criterion where the country the file was created in is Japan. With further respect to graph 900 of FIG. 9 and with continued reference to Query Q, suppose nodes 910 and 918 were created in Japan. In this context, filter applicator 212 applies the first weight to both nodes 910 and 918.

In step 1106, a second weight of the weights is applied to a second node of the graph index representative of a second file, the second file satisfying the respective filter criterion of the second weight. For example, filter applicator 212 of FIG. 2 applies a weight corresponding to a second filter criterion to nodes of graph index 120 that are representative of files satisfying the second filter criterion. With reference to the non-limiting example of Query Q, filter applicator 212 applies a second weight value to nodes that satisfy the year filter criterion where the creation year is prior to 2004. With further respect to graph 900 of FIG. 9 and with continued reference to Query Q, suppose nodes 912, 918, 920, and 924 were created prior to the year 2004. In this context, filter applicator 212 applies the second weight to nodes 912, 918, 920, and 924.

Thus, example embodiments of applying weight values to nodes of a graph index have been described with respect to flowchart 1100 of FIG. 11. By applying weights to nodes based on filter criterion, embodiments of the present disclosure increase the accuracy in traversal of the graph index to locate a node satisfying a search result of a query. For example, applying the weights to nodes 910, 912, 918, 920, and 924 increase the likelihood of graph searcher 208 in traversing to a weighted node than an un-weighted node. For instance, at node 906, graph searcher 208 is more likely to traverse to nodes 910 or 912 than node 914. As also described herein, filters can be prioritized so that a corresponding weight of one filter has a higher value than a corresponding weight of another filter. In the context of the non-limiting example described with respect to FIG. 11, graph 900, and Query Q, suppose the weight corresponding to the first filter criterion is greater than the weight corresponding to the second filter criterion. In this context, at node 906, graph searcher 208 is more likely to traverse to node 910 than to node 912, as the weight applied to node 910 is higher than the weight applied to node 912.

In the examples described with respect to FIG. 11, weight values increase the likelihood of graph searcher 208 in traversing to a node with the weight applied thereto than to a node without the weight applied thereto. However; it is further contemplated herein that a weight applied to a node can decrease the likelihood of graph searcher 208 traversing to the node or remove the node from consideration in traversal of graph 900. For instance, in an embodiment, if a node fails to satisfy a filter criterion, filter applicator 212 can apply a weight that removes the node from consideration (e.g., applying a multiplicative weight value of “0” to the node). By removing such nodes from traversal of the graph, filter applicator 212 can decrease the compute resources expended by graph searcher 208 in traversing the modified version of graph 900. In another embodiment, filter applicator 212 applies a weight that decreases the likelihood of traversal to a node. For example, by applying a fraction or decimal multiplicative weight value to a node that fails to satisfy a filter criterion and a whole number weight value to a node that satisfies the filter criterion, or by applying a negative weight value to a node that fails to satisfy a filter criterion.

### III. Embodiments for Search System Training

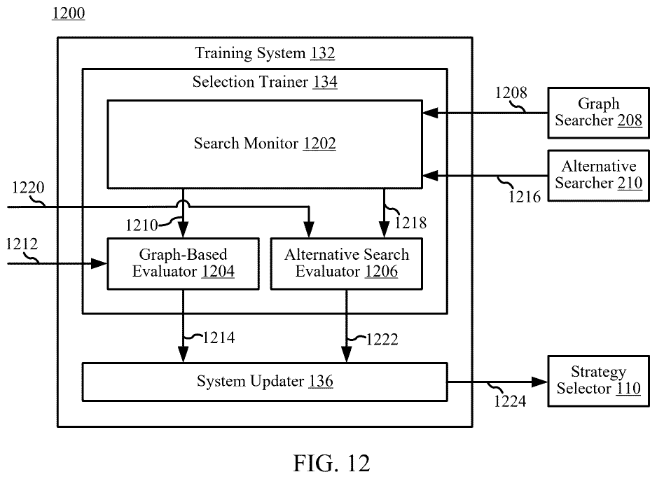

As described herein, embodiments of search systems can cause different search strategies to be utilized based on selectivity of filters associated with the query having a predetermined relationship with a predetermined threshold. The predetermined thresholds can be determined automatically, semi-automatically, or manually, depending on the implementation. For instance, in accordance with an embodiment, a training system is utilized to determine the predetermined threshold. The training system can utilize existing search system performance data or benchmark data, depending on the implementation. Such training systems can be configured in various ways, in embodiments. For example, FIG. 12 shows a block diagram of a system 1200 for training a search system, in accordance with an example embodiment. As shown in FIG. 12, system 1200 comprises training system 132 (comprising selection trainer 134 and system updater 136) and strategy selector 110, as described with respect to FIG. 1, as well as graph searcher 208 and alternative searcher 210. As also shown in FIG. 12, selection trainer 134 comprises a search monitor 1202, a graph-based evaluator 1204, and an alternative search evaluator 1206, each of which are implemented as subcomponents and/or subservices of selection trainer 134.

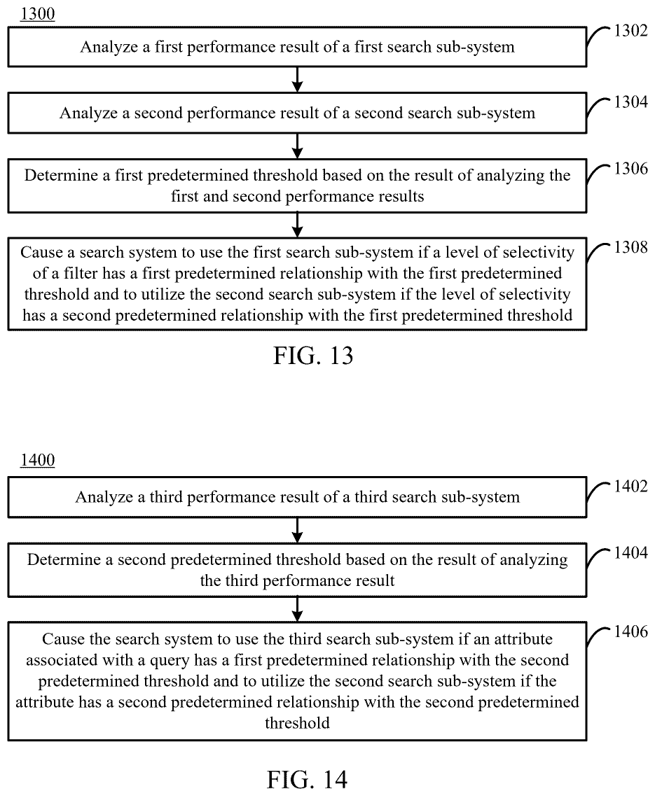

To better understand the operation of training system 132 of FIG. 12, FIG. 12 is further described with respect to FIG. 13. FIG. 13 shows a flowchart 1300 of a process for training a search system, in accordance with an example embodiment. In an embodiment, training system 132 of FIG. 12 operates according to one or more steps of flowchart 1300. Note that not all steps of flowchart 1300 need be performed in all embodiments. Further structural and operational embodiments will be apparent to persons skilled in the relevant art(s) based on the following descriptions of FIGS. 12 and 13.

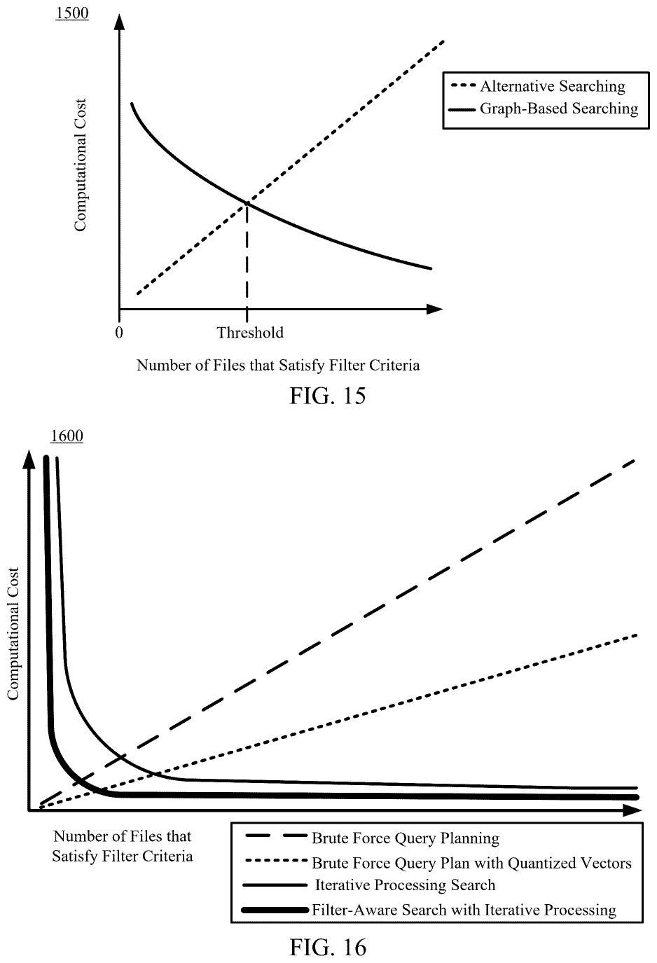

Flowchart 1300 begins with step 1302. In step 1302, a first performance result of a first search sub-system is analyzed. For example, graph-based evaluator 1204 evaluates performance results of graph searcher 208. In an implementation, graph-based evaluator 1204 evaluates stored results 1212 representative of past search performance of graph searcher 208. In another embodiment, graph-based evaluator 1204 receives monitored results 1210 from search monitor 1202. Search monitor 1202 generates monitored results 1210 by monitoring search results 1208 generated by graph searcher 208 executing searches of graph index 120. In an embodiment, monitored results 1210 and/or stored results 1212 including compute resources expended by graph searcher 208 in executing the search, the query, a number of candidates considered in the search, whether or not the search was successful, a time taken to execute the search, and/or other performance information related to the search. In an embodiment, personal identifying information is removed from monitored results 1210 and/or stored results 1212 prior to evaluation by graph-based evaluator 1204. In an embodiment, graph-based evaluator 1204 is able to determine a computational cost in compute resources expended to execute searches by graph searcher 208 based on the evaluated results. An example graph illustrating this computational cost is further described with respect to FIG. 15. In another embodiment, graph-based evaluator 1204 is able to determine a latency in responding to a search query by graph searcher 208 based on the evaluated results. Example graphs illustrating the latency in responding to a search query by graph searcher 208 are further described with respect to FIG. 15. In embodiments, graph-based evaluator 1204 generates an evaluation result 1214 representative of the evaluation of stored results 1212 and/or monitored results 1210.

In an embodiment, graph-based evaluator 1204 causes graph searcher 208 to execute searches based on benchmark data to generate a benchmark evaluation dataset as evaluation result 1214. In this context, graph-based evaluator 1204 is able to evaluate an expected performance of graph searcher 208 prior to deployment of graph searcher 208 or in an offline mode where graph searcher 208 is evaluated independent of its deployment in a networked computing system. In this example, the benchmark data can be generated from public data, data generated by a developer system of a networked computing system, generated utilizing a generative artificial intelligence model configured to generate benchmark query data, or generated utilizing another system for generating benchmark data. In an alternative or additional embodiment, graph-based evaluator 1204 evaluates live execution of searches by graph searcher 208 against user queries. In this context, personal identifying information can be removed from the monitored or stored results prior to evaluation. By utilizing live execution of searches or recent execution of searches, selection trainer 134 is able to monitor and adjust for real world usage of search system 104 and its components. This allows selection trainer 134 to identify and correct errors in the search system after deployment, further reducing compute resources expended in satisfying queries.

In step 1304, a second performance result of a second search sub-system is analyzed. For example, alternative search evaluator 1206 evaluates performance results of alternative searcher 210. In an implementation, alternative searcher evaluator 1206 evaluates stored results 1220 representative of past search performance of alternative searcher 210. In another embodiment, alternative searcher evaluator 1206 receives monitored results 1218 from search monitor 1202. Search monitor 1202 generates monitored results 1218 by monitoring search results 1216 generated by alternative searcher 210 executing alternative search strategies. In an embodiment, monitored results 1218 and/or stored results 1220 including compute resources expended by alternative searcher 210 in executing the search, the query, a number of candidates considered in the search, whether or not the search was successful, a time taken to execute the search, and/or other performance information related to the search. In an embodiment, personal identifying information is removed from monitored results 1218 and/or stored results 1220 prior to evaluation by alternative search evaluator 1206. In an embodiment, alternative search evaluator 1206 is able to determine a computational cost in compute resources expended to execute searches by alternative searcher 210 based on the evaluated results. An example graph illustrating this computational cost is further described with respect to FIG. 15. In another embodiment, alternative search evaluator 1206 is able to determine a latency in responding to a search query by alternative searcher 210 based on the evaluated results. Example graphs illustrating the latency in responding to a search query by alternative searcher 210 are further described with respect to FIG. 16. In embodiments, alternative search evaluator 1206 generates an evaluation result 1222 representative of the evaluation of stored results 1220 and/or monitored results 1218.

In an embodiment, alternative search evaluator 1206 causes alternative searcher 210 to execute searches based on benchmark data to generate a benchmark evaluation dataset as evaluation result 1222, in a similar manner as graph-based evaluator 1204 generates a benchmark evaluation dataset as evaluation result 1214. Alternatively or additionally, alternative search evaluator 1206 evaluates live execution of searches executed by alternative searcher 210, in a similar manner as graph-based evaluator 1204 evaluates live execution of searches executed by graph searcher 208. By utilizing live execution of searches or recent execution of searches, selection trainer 134 is able to monitor and adjust for real world usage of search system 104 and its components. This allows selection trainer 134 to identify and correct errors in the search system after deployment, further reducing compute resources expended in satisfying queries.

In step 1306, a first predetermined threshold is determined based on the result of analyzing the first and second performance results. For example, system updater 136 determines a first predetermined threshold based on a result of analyzing evaluation result 1214 and evaluation result 1222. In an example embodiment, the predetermined threshold represents a level of selectivity at which the estimated computational cost of utilizing a graph-index-based search strategy of graph searcher 208 is higher than the estimated computational cost of utilizing an alternative search strategy of alternative searcher 210. An example of this threshold is represented in FIG. 15, and described elsewhere herein.

In step 1308, a search system is caused to use the first search sub-system if a level of selectivity of a filter has a first predetermined relationship with the first predetermined threshold and to utilize the second search sub-system if the level of selectivity has a second predetermined relationship with the first predetermined threshold. For example, system updater 136 provides an update signal 1224 to strategy selector 110, causing strategy selector 110 to utilize the predetermined threshold determined in step 1306 in determining whether to use the graph-index-based search strategy of graph searcher 208 or an alternative search strategy of alternative searcher 210, as described in step 702 of flowchart 700 of FIG. 7, as well as elsewhere herein. By determining this threshold, training system 132 is able to improve the performance of search system 104 in satisfying search queries, as a different search strategy is selected depending on the computational resources expended for a level of selectivity of filters applied to the query.

As described elsewhere herein, some search systems can utilize many different search strategies. In this context, training system 132 can determine multiple predetermined thresholds to be used in determining which search strategy to use. Training system 132 can operate in various ways to determine the multiple predetermined thresholds. For example, FIG. 14 shows a flowchart 1400 of a process for training a search system with multiple predetermined thresholds, in accordance with an example embodiment. In an embodiment, training system 132 of FIG. 12 operates according to one or more steps of flowchart 1400. Note that not all steps of flowchart 1400 need be performed in all embodiments. Further structural and operational embodiments will be apparent to persons skilled in the relevant art(s) based on the following description of FIG. 14.

Flowchart 1400 begins with step 1402. In step 1402, a third performance result of a third search sub-system is analyzed. For example, alternative search evaluator 1206 can evaluate a performance of a second alternative search strategy. As a non-limiting example described with respect to flowchart 800 of FIG. 8, suppose alternative search evaluator 1206 evaluates a performance of utilizing the tree-based range scan strategy described in step 804 and a performance of utilizing the data loading strategy described in step 806. Alternative search evaluator 1206 can evaluate these search strategies in a similar manner as described with respect to step 1304 of flowchart 1300 of FIG. 13.

In step 1404, a second predetermined threshold is determined based on the result of analyzing the third performance result. For example, system updater 136 can determine a second predetermined threshold based on a result of analyzing the third performance result in step 1402. In an embodiment described with respect to alternative search evaluator 1206 evaluating multiple alternative search strategies, this second predetermined threshold represents a threshold at which the computational cost of utilizing the first alternative search strategy is greater than the computational cost of utilizing the second alternative search strategy. For example, with respect to flowchart 800, the second predetermined threshold corresponds to the number of vectors in a range of vectors at which the computational cost of utilizing the tree-based range scan search strategy of step 804 is higher than the computational cost of utilizing the data loading search strategy of step 806.

In step 1406, the search system is caused to use the third search sub-system if an attribute associated with a query has a first predetermined relationship with the second predetermined threshold and to utilize the second search sub-system if the attribute has a second predetermined relationship with the second predetermined threshold. For example, system updater 136 provides update signal 1224 to strategy selector 110, causing strategy selector 110 to utilize the second predetermined threshold determined in step 1404 in determining whether to use the first alternative search strategy of alternative searcher 210 or the second alternative search strategy of alternative searcher 210, as described in step 802 of flowchart 800 of FIG. 8, as well as elsewhere herein. By determining this threshold, training system 132 is able to improve the performance of search system 104 in satisfying search queries, as a different search strategy is selected depending on the computational resources expended for a level of selectivity of filters applied to the query.

Flowchart 1400 has been described as determining an additional threshold for determining which alternative search strategy to utilize. In embodiments, training system 132 can determine multiple additional thresholds for determining which alternative search strategy to use from among three or more alternative search strategies. In another alternative embodiment, training system 132 determines an additional threshold for determining a type of graph-based search strategy graph searcher 208 is to utilize, in situations where multiple potential graph-based search strategies can be used by graph searcher 208.

### IV. Example Embodiments of Search Strategy Performances

As described herein, embodiments of search system 104 can utilize filter aware searching to determine which search strategy to utilize in generating a search result that satisfies a query. In embodiments, different search strategies can have different levels of performance. By selecting which search strategy to utilize based on selectivity of filters applied to a query, embodiments of search system 104 improve the utilization of computational resources in satisfying the query. To illustrate differences in computational performance of different search strategies, several example graphs are shown herein. For instance, FIGS. 15 and 16 show graphs 1500 and 1600 of search strategy performances, in accordance with an example embodiment. For example, graph 1500 shows an example where graph-based search strategy entitled “Graph-Based Searching” and an alternative search strategy entitled “Alternate Searching” are used. In an embodiment, graph searcher 208 of FIG. 2 executes the Graph-Based Searching strategy and alternative searcher 210 of FIG. 2 executes the Alternative Searching strategy. In an embodiment, the Graph-Based Searching strategy is an approximate search with pre-filtering utilizing an inverted index, as described elsewhere herein. In an embodiment, the Alternative Searching strategy is a document load search with pre-filtering that searches through loaded documents. As also shown in graph 1500, a threshold entitled “Threshold” is identified where the computational cost of the Alternate Searching strategy is higher than the computational cost of the Graph-Based Searching strategy as the number of files that satisfy the filter criteria increases. In an embodiment, as the number of files that satisfy the filter criteria increases, the rate of the hit count of search filters also increases. In other words, once the number of match points of data in files 128 to filter criteria of a query is higher than Threshold, the number of compute resources, the amount of processing cycles, and/or other computational hardware costs to execute the Alternative Searching strategy surpasses the number of compute resources, the amount of processing cycles, and/or other computational hardware costs to execute the Graph-Based Searching strategy. In an embodiment, Threshold is the first predetermined threshold described in step 702 of flowchart 700 of FIG. 7.

Graph 1600 shows a comparative performance between an iterative post processing search strategy, a brute force querying search strategy, an advance query planning search strategy, and a filter-aware searching strategy. As shown in graph 1600, the filter-aware search strategy has a lower latency than iterative post-processing. As further shown in graph 1600, at certain numbers of filter match points, the latency of using either simple query planning or advanced query planning strategies are lower than filter-aware search strategy. Thus, when the number of filter match points is below these numbers, the query planning strategies utilizing brute force or other alternatives are more efficient than iterative post processing. In an embodiment, a training system such as training system 132 can determine the thresholds for these differences in efficiencies and cause strategy selector 110 to select a search strategy based on these thresholds and the selectivity of a received query.

Thus, example performance graphs of different search strategies have been shown and described with respect to FIGS. 15 and 16. However, these performance graphs are shown for illustrative purposes and are non-limiting. It is further contemplated herein that other search strategies can be utilized, and implementations of such search strategies can produce different performance graphs. Furthermore, some implementations of search strategies can produce results that deviate from averages represented by the graphs of FIGS. 15 and 16.

### V. Example Computer System Implementation

Systems, devices, components, and/or techniques described herein are implemented in hardware, or hardware combined with one or both of software and/or firmware. For example, filter determiner 108, strategy selector 110, result searcher 112, application 116, graph index 120, selection trainer 134, system updater 136, inverted index generator 202, selectivity evaluator 204, selector 206, graph searcher 208, alternative searcher 210, filter applicator 212, search monitor 1202, graph-based evaluator 1204, and/or alternative search evaluator 1206, and/or each of the components described therein, and/or the steps of flowcharts 300, 400, 500, 600, 700, 800, 1000, 1100, 1300, and/or 1400 are each implemented as computer program code/instructions configured to be executed in one or more processors and stored in a computer readable storage medium. Alternatively, computing device 102, search system 104, server devices 106, filter determiner 108, strategy selector 110, result searcher 112, application 116, data store 118, graph index 120, training system 132, selection trainer 134, system updater 136, inverted index generator 202, selectivity evaluator 204, selector 206, graph searcher 208, alternative searcher 210, filter applicator 212, search monitor 1202, graph-based evaluator 1204, and/or alternative search evaluator 1206, and/or each of the components described therein, and/or the steps of flowcharts 300, 400, 500, 600, 700, 800, 1000, 1100, 1300, and/or 1400 are implemented in one or more SoCs (system on chip). An SoC includes an integrated circuit chip that includes one or more of a processor (e.g., a central processing unit (CPU), microcontroller, microprocessor, digital signal processor (DSP), etc.), memory, one or more communication interfaces, and/or further circuits, and optionally executes received program code and/or include embedded firmware to perform functions.

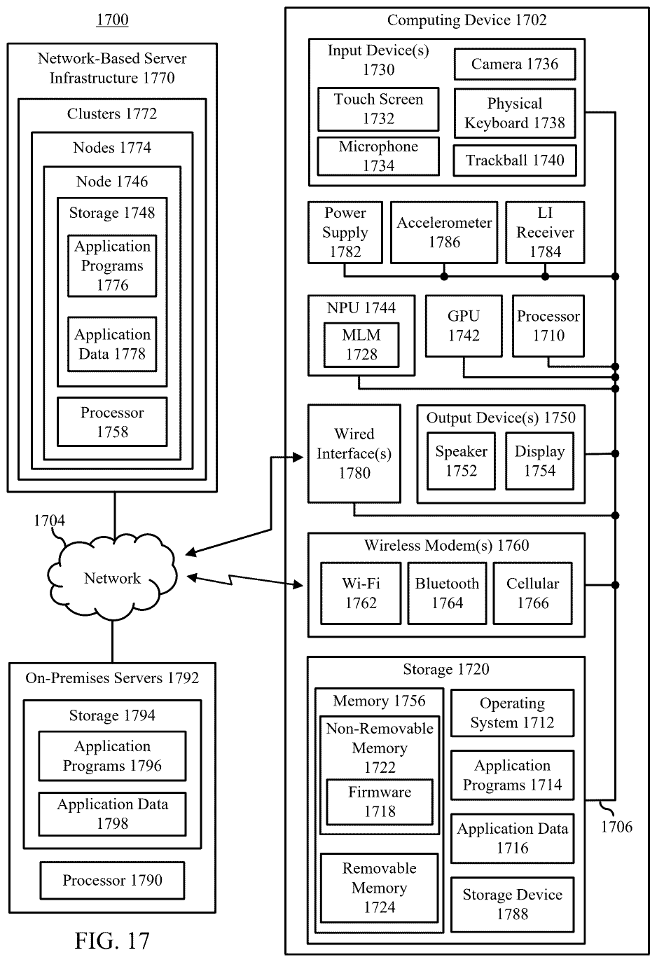

Embodiments disclosed herein can be implemented in one or more computing devices that are mobile (a mobile device) and/or stationary (a stationary device) and include any combination of the features of such mobile and stationary computing devices. Examples of computing devices in which embodiments are implementable are described as follows with respect to FIG. 17. FIG. 17 shows a block diagram of an exemplary computing environment 1700 that includes a computing device 1702. Computing device 1702 is an example of computing device 102, search system 104, server devices 106, data store 118, and/or training system 132, which each include one or more of the components of computing device 1702. In some embodiments, computing device 1702 is communicatively coupled with devices (not shown in FIG. 17) external to computing environment 1700 via network 1704. In accordance with an embodiment, network 1704 is an example of network 140 of FIG. 1. Network 1704 comprises one or more networks such as local area networks (LANs), wide area networks (WANs), enterprise networks, the Internet, etc. In examples, network 1704 includes one or more wired and/or wireless portions. In some examples, network 1704 additionally or alternatively includes a cellular network for cellular communications. Computing device 1702 is described in detail as follows.

Computing device 1702 can be any of a variety of types of computing devices. Examples of computing device 1702 include a mobile computing device such as a handheld computer (e.g., a personal digital assistant (PDA)), a laptop computer, a tablet computer, a hybrid device, a notebook computer, a netbook, a mobile phone (e.g., a cell phone, a smart phone, etc.), a wearable computing device (e.g., a head-mounted augmented reality and/or virtual reality device including smart glasses), or other type of mobile computing device. In an alternative example, computing device 1702 is a stationary computing device such as a desktop computer, a personal computer (PC), a stationary server device, a minicomputer, a mainframe, a supercomputer, etc.

As shown in FIG. 17, computing device 1702 includes a variety of hardware and software components, including a processor 1710, a storage 1720, a graphics processing unit (GPU) 1742, a neural processing unit (NPU) 1744, one or more input devices 1730, one or more output devices 1750, one or more wireless modems 1760, one or more wired interfaces 1780, a power supply 1782, a location information (LI) receiver 1784, and an accelerometer 1786. Storage 1720 includes memory 1756, which includes non-removable memory 1722 and removable memory 1724, and a storage device 1788. Storage 1720 also stores an operating system 1712, application programs 1714, and application data 1716. Wireless modem(s) 1760 include a Wi-Fi modem 1762, a Bluetooth modem 1764, and a cellular modem 1766. Output device(s) 1750 includes a speaker 1752 and a display 1754. Input device(s) 1730 includes a touch screen 1732, a microphone 1734, a camera 1736, a physical keyboard 1738, and a trackball 1740. Not all components of computing device 1702 shown in FIG. 17 are present in all embodiments, additional components not shown may be present, and in a particular embodiment any combination of the components are present. In examples, components of computing device 1702 are mounted to a circuit card (e.g., a motherboard) of computing device 1702, integrated in a housing of computing device 1702, or otherwise included in computing device 1702. The components of computing device 1702 are described as follows.

In embodiments, a single processor 1710 (e.g., central processing unit (CPU), microcontroller, a microprocessor, signal processor, ASIC (application specific integrated circuit), and/or other physical hardware processor circuit) or multiple processors 1710 are present in computing device 1702 for performing such tasks as program execution, signal coding, data processing, input/output processing, power control, and/or other functions. In examples, processor 1710 is a single-core or multi-core processor, and each processor core is single-threaded or multithreaded (to provide multiple threads of execution concurrently). Processor 1710 is configured to execute program code stored in a computer readable medium, such as program code of operating system 1712 and application programs 1714 stored in storage 1720. The program code is structured to cause processor 1710 to perform operations, including the processes/methods disclosed herein. Operating system 1712 controls the allocation and usage of the components of computing device 1702 and provides support for one or more application programs 1714 (also referred to as “applications” or “apps”). In examples, application programs 1714 include common computing applications (e.g., e-mail applications, calendars, contact managers, web browsers, messaging applications), further computing applications (e.g., word processing applications, mapping applications, media player applications, productivity suite applications), one or more machine learning (ML) models, as well as applications related to the embodiments disclosed elsewhere herein. In examples, processor(s) 1710 includes one or more general processors (e.g., CPUs) configured with or coupled to one or more hardware accelerators, such as one or more NPUs 1744 and/or one or more GPUs 1742.

Any component in computing device 1702 can communicate with any other component according to function, although not all connections are shown for ease of illustration. For instance, as shown in FIG. 17, bus 1706 is a multiple signal line communication medium (e.g., conductive traces in silicon, metal traces along a motherboard, wires, etc.) present to communicatively couple processor 1710 to various other components of computing device 1702, although in other embodiments, an alternative bus, further buses, and/or one or more individual signal lines is/are present to communicatively couple components. Bus 1706 represents one or more of any of several types of bus structures, including a memory bus or memory controller, a peripheral bus, an accelerated graphics port, and a processor or local bus using any of a variety of bus architectures.

Storage 1720 is physical storage that includes one or both of memory 1756 and storage device 1788, which store operating system 1712, application programs 1714, and application data 1716 according to any distribution. Non-removable memory 1722 includes one or more of RAM (random access memory), ROM (read only memory), flash memory, a solid-state drive (SSD), a hard disk drive (e.g., a disk drive for reading from and writing to a hard disk), and/or other physical memory device type. In examples, non-removable memory 1722 includes main memory and is separate from or fabricated in a same integrated circuit as processor 1710. As shown in FIG. 17, non-removable memory 1722 stores firmware 1718 that is present to provide low-level control of hardware. Examples of firmware 1718 include BIOS (Basic Input/Output System, such as on personal computers) and boot firmware (e.g., on smart phones). In examples, removable memory 1724 is inserted into a receptacle of or is otherwise coupled to computing device 1702 and can be removed by a user from computing device 1702. Removable memory 1724 can include any suitable removable memory device type, including an SD (Secure Digital) card, a Subscriber Identity Module (SIM) card, which is well known in GSM (Global System for Mobile Communications) communication systems, and/or other removable physical memory device type. In examples, one or more of storage device 1788 are present that are internal and/or external to a housing of computing device 1702 and are or are not removable. Examples of storage device 1788 include a hard disk drive, an SSD, a thumb drive (e.g., a USB (Universal Serial Bus) flash drive), or other physical storage device.

One or more programs are stored in storage 1720. Such programs include operating system 1712, one or more application programs 1714, and other program modules and program data. Examples of such application programs include computer program logic (e.g., computer program code/instructions) for implementing filter determiner 108, strategy selector 110, result searcher 112, application 116, graph index 120, selection trainer 134, system updater 136, inverted index generator 202, selectivity evaluator 204, selector 206, graph searcher 208, alternative searcher 210, filter applicator 212, search monitor 1202, graph-based evaluator 1204, and/or alternative search evaluator 1206, and/or each of the components described therein, and/or the steps of flowcharts 300, 400, 500, 600, 700, 800, 1000, 1100, 1300, and/or 1400.

Storage 1720 also stores data used and/or generated by operating system 1712 and application programs 1714 as application data 1716. Examples of application data 1716 include web pages, text, images, tables, sound files, video data, and other data. In examples, application data 1716 is sent to and/or received from one or more network servers or other devices via one or more wired or wireless networks. Storage 1720 can be used to store further data including a subscriber identifier, such as an International Mobile Subscriber Identity (IMSI), and an equipment identifier, such as an International Mobile Equipment Identifier (IMEI). Such identifiers can be transmitted to a network server to identify users and equipment.

In examples, a user enters commands and information into computing device 1702 through one or more input devices 1730 and receives information from computing device 1702 through one or more output devices 1750. Input device(s) 1730 includes one or more of touch screen 1732, microphone 1734, camera 1736, physical keyboard 1738 and/or trackball 1740 and output device(s) 1750 includes one or more of speaker 1752 and display 1754. Each of input device(s) 1730 and output device(s) 1750 are integral to computing device 1702 (e.g., built into a housing of computing device 1702) or are external to computing device 1702 (e.g., communicatively coupled wired or wirelessly to computing device 1702 via wired interface(s) 1780 and/or wireless modem(s) 1760). Further input devices 1730 (not shown) can include a Natural User Interface (NUI), a pointing device (computer mouse), a joystick, a video game controller, a scanner, a touch pad, a stylus pen, a voice recognition system to receive voice input, a gesture recognition system to receive gesture input, or the like. Other possible output devices (not shown) can include piezoelectric or other haptic output devices. Some devices can serve more than one input/output function. For instance, display 1754 displays information, as well as operating as touch screen 1732 by receiving user commands and/or other information (e.g., by touch, finger gestures, virtual keyboard, etc.) as a user interface. Any number of each type of input device(s) 1730 and output device(s) 1750 are present, including multiple microphones 1734, multiple cameras 1736, multiple speakers 1752, and/or multiple displays 1754.

In embodiments where GPU 1742 is present, GPU 1742 includes hardware (e.g., one or more integrated circuit chips that implement one or more of processing cores, multiprocessors, compute units, etc.) configured to accelerate computer graphics (two-dimensional (2D) and/or three-dimensional (3D)), perform image processing, and/or execute further parallel processing applications (e.g., training of neural networks, etc.). Examples of GPU 1742 perform calculations related to 3D computer graphics, include 2D acceleration and framebuffer capabilities, accelerate memory-intensive work of texture mapping and rendering polygons, accelerate geometric calculations such as the rotation and translation of vertices into different coordinate systems, support programmable shaders that manipulate vertices and textures, perform oversampling and interpolation techniques to reduce aliasing, and/or support very high-precision color spaces.

In examples, NPU 1744 (also referred to as an “artificial intelligence (AI) accelerator” or “deep learning processor (DLP)”) is a processor or processing unit configured to accelerate artificial intelligence and machine learning applications, such as execution of machine learning (ML) model (MLM) 1728. In an example, NPU 1744 is configured for a data-driven parallel computing and is highly efficient at processing massive multimedia data such as videos and images and processing data for neural networks. NPU 1744 is configured for efficient handling of AI-related tasks, such as speech recognition, background blurring in video calls, photo or video editing processes like object detection, etc.

In embodiments disclosed herein that implement ML models, NPU 1744 can be utilized to execute such ML models, of which MLM 1728 is an example. For instance, where applicable, MLM 1728 is a generative AI model that generates content that is complex, coherent, and/or original. For instance, a generative AI model can create sophisticated sentences, lists, ranges, tables of data, images, essays, and/or the like. An example of a generative AI model is a language model. A language model is a model that estimates the probability of a token or sequence of tokens occurring in a longer sequence of tokens. In this context, a “token” is an atomic unit that the model is training on and making predictions on. Examples of a token include, but are not limited to, a word, a character (e.g., an alphanumeric character, a blank space, a symbol, etc.), a sub-word (e.g., a root word, a prefix, or a suffix). In other types of models (e.g., image based models) a token may represent another kind of atomic unit (e.g., a subset of an image). Examples of language models applicable to embodiments herein include large language models (LLMs), text-to-image AI image generation systems, text-to-video AI generation systems, etc. A large language model (LLM) is a language model that has a high number of model parameters. In examples, an LLM has millions, billions, trillions, or even greater numbers of model parameters. Model parameters of an LLM are the weights and biases the model learns during training. Some implementations of LLMs are transformer-based LLMs (e.g., the family of generative pre-trained transformer (GPT) models). A transformer is a neural network architecture that relies on self-attention mechanisms to transform a sequence of input embeddings into a sequence of output embeddings (e.g., without relying on convolutions or recurrent neural networks).

In further examples, NPU 1744 is used to train MLM 1728. To train MLM 1728, training data that includes input features (attributes) and their corresponding output labels/target values (e.g., for supervised learning) is collected. A training algorithm is a computational procedure that is used so that MLM 1728 learns from the training data. Parameters/weights are internal settings of MLM 1728 that are adjusted during training by the training algorithm to reduce a difference between predictions by MLM 1728 and actual outcomes (e.g., output labels). In some examples, MLM 1728 is set with initial values for the parameters/weights. A loss function measures a dissimilarity between predictions by MLM 1728 and the target values, and the parameters/weights of MLM 1728 are adjusted to minimize the loss function. The parameters/weights are iteratively adjusted by an optimization technique, such as gradient descent. In this manner, MLM 1728 is generated through training by NPU 1744 to be used to generate inferences based on received input feature sets for particular applications. MLM 1728 is generated as a computer program or other type of algorithm configured to generate an output (e.g., a classification, a prediction/inference) based on received input features, and is stored in the form of a file or other data structure.

In examples, such training of MLM 1728 by NPU 1744 is supervised or unsupervised. According to supervised learning, input objects (e.g., a vector of predictor variables) and a desired output value (e.g., a human-labeled supervisory signal) train MLM 1728. The training data is processed, building a function that maps new data on expected output values. Example algorithms usable by NPU 1744 to perform supervised training of MLM 1728 in particular implementations include support-vector machines, linear regression, logistic regression, Naïve Bayes, linear discriminant analysis, decision trees, K-nearest neighbor algorithm, neural networks, and similarity learning.

In an example of supervised learning where MLM 1728 is an LLM, MLM 1728 can be trained by exposing the LLM to (e.g., large amounts of) text (e.g., predetermined datasets, books, articles, text-based conversations, webpages, transcriptions, forum entries, and/or any other form of text and/or combinations thereof). In examples, training data is provided from a database, from the Internet, from a system, and/or the like. Furthermore, an LLM can be fine-tuned using Reinforcement Learning with Human Feedback (RLHF), where the LLM is provided the same input twice and provides two different outputs and a user ranks which output is preferred. In this context, the ranking is utilized to improve the model. Further still, in example embodiments, an LLM is trained to perform in various styles, e.g., as a completion model (a model that is provided a few words or tokens and generates words or tokens to follow the input), as a conversation model (a model that provides an answer or other type of response to a conversation-style prompt), as a combination of a completion and conversation model, or as another type of LLM model.

According to unsupervised learning, MLM 1728 is trained to learn patterns from unlabeled data. For instance, in embodiments where MLM 1728 implements unsupervised learning techniques, MLM 1728 identifies one or more classifications or clusters to which an input belongs. During a training phase of MLM 1728 according to unsupervised learning, MLM 1728 tries to mimic the provided training data and uses the error in its mimicked output to correct itself (i.e., correct weights and biases). In further examples, NPU 1744 perform unsupervised training of MLM 1728 according to one or more alternative techniques, such as Hopfield learning rule, Boltzmann learning rule, Contrastive Divergence, Wake Sleep, Variational Inference, Maximum Likelihood, Maximum A Posteriori, Gibbs Sampling, and backpropagating reconstruction errors or hidden state reparameterizations.

Note that NPU 1744 need not necessarily be present in all ML model embodiments. In embodiments where ML models are present, any one or more of processor 1710, GPU 1742, and/or NPU 1744 can be present to train and/or execute MLM 1728.

One or more wireless modems 1760 can be coupled to antenna(s) (not shown) of computing device 1702 and can support two-way communications between processor 1710 and devices external to computing device 1702 through network 1704, as would be understood to persons skilled in the relevant art(s). Wireless modem 1760 is shown generically and can include a cellular modem 1766 for communicating with one or more cellular networks, such as a GSM network for data and voice communications within a single cellular network, between cellular networks, or between the mobile device and a public switched telephone network (PSTN). In examples, wireless modem 1760 also or alternatively includes other radio-based modem types, such as a Bluetooth modem 1764 (also referred to as a “Bluetooth device”) and/or Wi-Fi modem 1762 (also referred to as an “wireless adaptor”). Wi-Fi modem 1762 is configured to communicate with an access point or other remote Wi-Fi-capable device according to one or more of the wireless network protocols based on the IEEE (Institute of Electrical and Electronics Engineers) 802.11 family of standards, commonly used for local area networking of devices and Internet access. Bluetooth modem 1764 is configured to communicate with another Bluetooth-capable device according to the Bluetooth short-range wireless technology standard(s) such as IEEE 802.17.1 and/or managed by the Bluetooth Special Interest Group (SIG).

Computing device 1702 can further include power supply 1782, LI receiver 1784, accelerometer 1786, and/or one or more wired interfaces 1780. Example wired interfaces 1780 include a USB port, IEEE 1394 (FireWire) port, a RS-172 port, an HDMI (High-Definition Multimedia Interface) port (e.g., for connection to an external display), a DisplayPort port (e.g., for connection to an external display), an audio port, and/or an Ethernet port, the purposes and functions of each of which are well known to persons skilled in the relevant art(s). Wired interface(s) 1780 of computing device 1702 provide for wired connections between computing device 1702 and network 1704, or between computing device 1702 and one or more devices/peripherals when such devices/peripherals are external to computing device 1702 (e.g., a pointing device, display 1754, speaker 1752, camera 1736, physical keyboard 1738, etc.). Power supply 1782 is configured to supply power to each of the components of computing device 1702 and receives power from a battery internal to computing device 1702, and/or from a power cord plugged into a power port of computing device 1702 (e.g., a USB port, an A/C power port). LI receiver 1784 is useable for location determination of computing device 1702 and in examples includes a satellite navigation receiver such as a Global Positioning System (GPS) receiver and/or includes other type of location determiner configured to determine location of computing device 1702 based on received information (e.g., using cell tower triangulation, etc.). Accelerometer 1786, when present, is configured to determine an orientation of computing device 1702.

Note that the illustrated components of computing device 1702 are not required or all-inclusive, and fewer or greater numbers of components can be present as would be recognized by one skilled in the art. In examples, computing device 1702 includes one or more of a gyroscope, barometer, proximity sensor, ambient light sensor, digital compass, etc. In an example, processor 1710 and memory 1756 are co-located in a same semiconductor device package, such as being included together in an integrated circuit chip, FPGA, or system-on-chip (SOC), optionally along with further components of computing device 1702.

In embodiments, computing device 1702 is configured to implement any of the above-described features of flowcharts herein. Computer program logic for performing any of the operations, steps, and/or functions described herein is stored in storage 1720 and executed by processor 1710.

In some embodiments, server infrastructure 1770 is present in computing environment 1700 and is communicatively coupled with computing device 1702 via network 1704. Server infrastructure 1770, when present, is a network-accessible server set (e.g., a cloud-based environment or platform). As shown in FIG. 17, server infrastructure 1770 includes clusters 1772. Each of clusters 1772 comprises a group of one or more compute nodes and/or a group of one or more storage nodes. For example, as shown in FIG. 17, cluster 1772 includes nodes 1774. Each of nodes 1774 are accessible via network 1704 (e.g., in a “cloud-based” embodiment) to build, deploy, and manage applications and services. In examples, any of nodes 1774 is a storage node that comprises a plurality of physical storage disks, SSDs, and/or other physical storage devices that are accessible via network 1704 and are configured to store data associated with the applications and services managed by nodes 1774.

Each of nodes 1774, as a compute node, comprises one or more server computers, server systems, and/or computing devices. For instance, a node 1774 in accordance with an embodiment includes one or more of the components of computing device 1702 disclosed herein. Each of nodes 1774 is configured to execute one or more software applications (or “applications”) and/or services and/or manage hardware resources (e.g., processors, memory, etc.), which are utilized by users (e.g., customers) of the network-accessible server set. In examples, as shown in FIG. 17, nodes 1774 includes a node 1746 that includes storage 1748 and/or one or more of a processor 1758 (e.g., similar to processor 1710, GPU 1742, and/or NPU 1744 of computing device 1702). Storage 1748 stores application programs 1776 and application data 1778. Processor(s) 1758 operate application programs 1776 which access and/or generate related application data 1778. In an implementation, nodes such as node 1746 of nodes 1774 operate or comprise one or more virtual machines, with each virtual machine emulating a system architecture (e.g., an operating system), in an isolated manner, upon which applications such as application programs 1776 are executed.

In embodiments, one or more of clusters 1772 are located/co-located (e.g., housed in one or more nearby buildings with associated components such as backup power supplies, redundant data communications, environmental controls, etc.) to form a datacenter, or are arranged in other manners. Accordingly, in an embodiment, one or more of clusters 1772 are included in a datacenter in a distributed collection of datacenters. In embodiments, exemplary computing environment 1700 comprises part of a cloud-based platform.

In an embodiment, computing device 1702 accesses application programs 1776 for execution in any manner, such as by a client application and/or a browser at computing device 1702.

In an example, for purposes of network (e.g., cloud) backup and data security, computing device 1702 additionally and/or alternatively synchronizes copies of application programs 1714 and/or application data 1716 to be stored at network-based server infrastructure 1770 as application programs 1776 and/or application data 1778. In examples, operating system 1712 and/or application programs 1714 include a file hosting service client configured to synchronize applications and/or data stored in storage 1720 at network-based server infrastructure 1770.

In some embodiments, on-premises servers 1792 are present in computing environment 1700 and are communicatively coupled with computing device 1702 via network 1704. On-premises servers 1792, when present, are hosted within an organization's infrastructure and, in many cases, physically onsite of a facility of that organization. On-premises servers 1792 are controlled, administered, and maintained by IT (Information Technology) personnel of the organization or an IT partner to the organization. Application data 1798 can be shared by on-premises servers 1792 between computing devices of the organization, including computing device 1702 (when part of an organization) through a local network of the organization, and/or through further networks accessible to the organization (including the Internet). Furthermore, in examples, on-premises servers 1792 serve applications such as application programs 1796 to the computing devices of the organization, including computing device 1702. Accordingly, in examples, on-premises servers 1792 include storage 1794 (which includes one or more physical storage devices such as storage disks and/or SSDs) for storage of application programs 1796 and application data 1798 and include a processor 1790 (e.g., similar to processor 1710, GPU 1742, and/or NPU 1744 of computing device 1702) for execution of application programs 1796. In some embodiments, multiple processors 1790 are present for execution of application programs 1796 and/or for other purposes. In further examples, computing device 1702 is configured to synchronize copies of application programs 1714 and/or application data 1716 for backup storage at on-premises servers 1792 as application programs 1796 and/or application data 1798.

Embodiments described herein may be implemented in one or more of computing device 1702, network-based server infrastructure 1770, and on-premises servers 1792. For example, in some embodiments, computing device 1702 is used to implement systems, clients, or devices, or components/subcomponents thereof, disclosed elsewhere herein. In other embodiments, a combination of computing device 1702, network-based server infrastructure 1770, and/or on-premises servers 1792 is used to implement the systems, clients, or devices, or components/subcomponents thereof, disclosed elsewhere herein.

As used herein, the terms “computer program medium,” “computer-readable medium,” “computer-readable storage medium,” and “computer-readable storage device,” etc., are used to refer to physical hardware media. Examples of such physical hardware media include any hard disk, optical disk, SSD, other physical hardware media such as RAMs, ROMs, flash memory, digital video disks, zip disks, MEMs (microelectronic machine) memory, nanotechnology-based storage devices, and further types of physical/tangible hardware storage media of storage 1720. Such computer-readable media and/or storage media are distinguished from and non-overlapping with communication media, propagating signals, and signals per se. Stated differently, “computer program medium,” “computer-readable medium,” “computer-readable storage medium,” and “computer-readable storage device” do not encompass communication media, propagating signals, and signals per se. Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared, and other wireless media, as well as wired media. Embodiments are also directed to such communication media that are separate and non-overlapping with embodiments directed to computer-readable storage media.

As noted above, computer programs and modules (including application programs 1714) are stored in storage 1720. Such computer programs can also be received via wired interface(s) 1760 and/or wireless modem(s) 1760 over network 1704. Such computer programs, when executed or loaded by an application, enable computing device 1702 to implement features of embodiments discussed herein. Accordingly, such computer programs represent controllers of the computing device 1702.

Embodiments are also directed to computer program products comprising computer code or instructions stored on any computer-readable medium or computer-readable storage medium. Such computer program products include the physical storage of storage 1720 as well as further physical storage types.

### VI. Additional Exemplary Embodiments

A search method is described herein. The search method comprises: receiving, from a computing device, a first query; determining a first filter criterion based on first metadata corresponding to the first query; generating a first inverted index based on the first filter criterion; determining if a first level of selectivity of the first inverted index has a predetermined relationship with a first predetermined threshold; utilizing a first search strategy to generate a first search result satisfying the first query, the first search strategy depending on whether or not the first level of selectivity has a predetermined relationship with a predetermined threshold; and providing, to the computing device, the first search result.

In a further example of the foregoing search method, the first query comprises the first metadata.

In a further example of the foregoing search method, the inverted index indicates a first term of the first metadata and a first file associated with the first term.

In a further example of the foregoing search method, the first search strategy is a graph-index based strategy.

In a further example of the foregoing search method, the first search strategy is an alternative search strategy to a graph-index-based strategy.

In a further example of the foregoing search method, the alternative search strategy is a document loading strategy.

In a further example of the foregoing search method, the alternative search strategy is a range scan search strategy.

In a further example of the foregoing search method, the range scan search strategy is a tree-based range scan search strategy.

In a further example of the foregoing search method, said utilizing the first search strategy to identify the first search result comprises: selecting the first search strategy based on said first level of selectivity of the first inverted index has a predetermined relationship with a first predetermined threshold, the first search strategy configured to reduce compute resources expended in generating the first search result.

In a further example of the foregoing search method, said generating a first inverted index based on the first filter criterion comprises: accessing first file metadata of the first file; identifying an instance of the first term in the first file metadata; and generating the first inverted index based at least on said identifying the instance of the first term in the first file metadata.

In a further example of the foregoing search method, said generating the first inverted index based at least on said identifying the instance of the first term in the first file metadata comprises: generating a bit set having a first value indicating the instance of the first term is present in the first file metadata and a second value indicating the instance of the first term is not present in second file metadata of a second file; and generating the inverted index based at least on the bit set.

In a further example of the foregoing search method, said utilizing a first search strategy to generate a first search result satisfying the first query comprises: applying a first weight to a first node of a graph index and a second weight to a second node of the graph index resulting in a modified graph index, the first node representative of the first file and the second node representative of the second file, the first weight increasing a likelihood of traversing to first node and the second weight decreasing a likelihood of traversing to the second node; traversing the modified graph index by traversing to the first node without traversing to the second node; and generating the first search result based at least on a result of said traversing the modified graph.

In a further example of the foregoing search method, said generating the first inverted index comprises: accessing a previously generated inverted index; and utilizing the previously generated inverted index as the first inverted index.

In a further example of the foregoing search method, said utilizing the first search strategy comprises: applying the first inverted index to a graph index to generate a modified graph index; traversing the modified graph index to identify a node of the modified graph index that satisfies the first query; and generating the first search result based on the identified node.

In a further example of the foregoing search method, wherein said applying the first inverted index to the graph index comprises: determining a value of a first weight corresponding to the first filter criterion and a value of a second weight corresponding to a second filter criterion based on the first filter criterion being assigned a higher level of priority than the second filter criterion, the value of the first weight higher than the value of the second weight. Wherein said generating the modified graph index comprises: applying the first weight to a first node of the graph index representative of the first file, the first file satisfying the first filter criterion, and applying the second weight to a second node of the graph index representative of a second file, the second file satisfying the second filter criterion.

In a further example of the foregoing search method, wherein the search method further comprises: receiving a second query comprising second metadata; determining a second filter criterion based on the second metadata; generating a second inverted index based on the second filter criterion; determining a second level of selectivity of the second inverted index has a different predetermined relationship with the first predetermined threshold; utilizing a second search strategy to generate a second search result satisfying the second query.

In a further example of the foregoing search method, wherein said utilizing the second search strategy comprises: determining if a number of vectors in a range of vectors representing candidate results has a predetermined relationship with a second predetermined threshold. If the number of vectors has the predetermined relationship with the second predetermined threshold: utilizing a tree-based range scan as the second search strategy to generate the second search result. If the number of vectors does not have the predetermined relationship with the second predetermined threshold: loading data from a document store corresponding to the vectors to generate the second search result.

A training method is described herein. The training method comprises: analyzing a first performance result of a first search sub-system; analyzing a second performance result of a second search sub-system; determining a first predetermined threshold based on the result of analyzing the first and second performance results; and causing a search system to use the first search sub-system if a level of selectivity of a filter has a predetermined relationship with the first predetermined threshold and to utilize the second search sub-system if the level of selectivity has a second predetermined relationship with the predetermined threshold.

In a further example of the foregoing training method, the first search sub-system is a graph-index-based search sub-system.

In a further example of the foregoing training method, the first second sub-system is a graph-index-based search sub-system.

In a further example of the foregoing training method, the first second sub-system is an alternative search sub-system that utilizes a search strategy alternative to a graph-index-based search strategy.

In a further example of the foregoing training method, the training method further comprises: analyzing a third performance result of a third search sub-system; and determining a second predetermined threshold based on the result of analyzing the third performance result.

In a further example of the foregoing training method, the third search sub-system utilizes a different graph-index-based search strategy and the training method further comprises: causing the search system to utilize the first search sub-system if an attribute associated with the query has a first predetermined relationship with the second predetermined threshold and to utilize the third search sub-system if the attribute has a second predetermined relationship with the second predetermined threshold.

In a further example of the foregoing training method, the third search sub-system is a different alternative search strategy alternative to the graph-index-based search strategy and the training method further comprises: causing the search system to utilize the second search sub-system if an attribute associated with the query has a first predetermined relationship with the second predetermined threshold and to utilize the third search sub-system if the attribute has a second predetermined relationship with the second predetermined threshold.

In a further example of the foregoing search method or training method, the first predetermined relationship with the first predetermined threshold indicates a level of selectivity of the search query is below a predetermined threshold and the second predetermined relationship with the first predetermined threshold indicates the level of selectivity of the search query is above the predetermined threshold.

A system comprising a processor and memory is described herein. The memory storing program code is structured to cause the processor to perform any of the foregoing search and/or training methods.

A query search computing device comprising a processor. The processor is caused to perform any of the foregoing search and/or training methods.

In a further example of the foregoing query search computing device, the query search computing device further comprises a filter determiner, a strategy selector, and a result searcher that cause the processor to perform any of the foregoing search methods.

In a further example of the foregoing query search computing device, the query search computing device further comprises a selection trainer and a system updater that cause the processor to perform any of the foregoing training methods.

A computer-readable storage medium encoded with program instructions that, when executed by a processor circuit, perform any of the foregoing search and/or training methods described herein.

### VII. Conclusion

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the discussion, unless otherwise stated, adjectives modifying a condition or relationship characteristic of a feature or features of an implementation of the disclosure, should be understood to mean that the condition or characteristic is defined to within tolerances that are acceptable for operation of the implementation for an application for which it is intended. Furthermore, if the performance of an operation is described herein as being “in response to” one or more factors, it is to be understood that the one or more factors may be regarded as a sole contributing factor for causing the operation to occur or a contributing factor along with one or more additional factors for causing the operation to occur, and that the operation may occur at any time upon or after establishment of the one or more factors. Still further, where “based on” is used to indicate an effect being a result of an indicated cause, it is to be understood that the effect is not required to only result from the indicated cause, but that any number of possible additional causes may also contribute to the effect. Thus, as used herein, the term “based on” should be understood to be equivalent to the term “based at least on.”

Numerous example embodiments have been described above. Any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

Furthermore, example embodiments have been described above with respect to one or more running examples. Such running examples describe one or more particular implementations of the example embodiments; however, embodiments described herein are not limited to these particular implementations.

Moreover, according to the described embodiments and techniques, any components of systems, computing devices, search systems, server devices, data stores, training systems, and/or their functions may be caused to be activated for operation/performance thereof based on other operations, functions, actions, and/or the like, including initialization, completion, and/or performance of the operations, functions, actions, and/or the like.

In some example embodiments, one or more of the operations of the flowcharts described herein may not be performed. Moreover, operations in addition to or in lieu of the operations of the flowcharts described herein may be performed. Further, in some example embodiments, one or more of the operations of the flowcharts described herein may be performed out of order, in an alternate sequence, or partially (or completely) concurrently with each other or with other operations.

The embodiments described herein and/or any further systems, sub-systems, devices and/or components disclosed herein may be implemented in hardware (e.g., logic/electrical circuitry), or any combination of hardware with software (computer program code configured to be executed in one or more processors or processing devices) and/or firmware.

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described example embodiments, but should be defined only in accordance with the following claims and their equivalents.

What is claimed is:

1. A system comprising:
a processor; and
a memory device comprising programming instructions structured to cause the processor to:
receive a first query comprising first metadata,
determine a first filter criterion based on the first metadata,
generate a first inverted index based at least on the first filter criterion,
determine a level of selectivity of the first inverted index,
when the level of selectivity of the first inverted index has a first predetermined relationship with a first predetermined threshold:
utilize a first search strategy by applying the first inverted index to a graph index to generate a modified graph index and traversing the modified graph index to identify a first node of the modified graph index that satisfies the first query, and
provide, based on the node, a first search result as a response to the query, and
when the level of selectivity of the first inverted index has a second predetermined relationship with the first predetermined threshold:
utilize a second search strategy to generate the first search result, and
provide the first search result as a response to the query.

2. The system of claim 1, wherein:
the first search strategy is configured to utilize fewer compute resources than the second search strategy in providing search results when the level of selectivity of the first inverted index has the first predetermined relationship with the first predetermined threshold; and
the second search strategy is configured to utilize fewer compute resources than the first search strategy in providing search results when the level of selectivity of the first inverted index has the first predetermined relationship with the first predetermined threshold.

3. The system of claim 1, wherein to generate the first inverted index based on the first filter criterion, the programming instructions are further structured to cause the processor to:
access first file metadata of the first file;
identify an instance of the first term in the first file metadata; and
generate the first inverted index based on said identifying the instance of the first term in the first file metadata.

4. The system of claim 3, wherein to generate the first inverted index based on said identifying the instance of the first term in the first file metadata, the programming instructions are further structured to cause the processor to:
generate a bit set having a first value indicating the instance of the first term is present in the first file metadata and a second value indicating the instance of the first term is not present in second file metadata of a second file; and
generate the inverted index based at least on the bit set.

5. The system of claim 4, wherein to utilize the first search strategy to identify the first node the first search result satisfying the first query, the programming instructions are further structured to cause the processor to:
apply a first weight to the first node of the graph index and a second weight to a second node of the graph index resulting in the modified graph index, the first node representative of the first file and the second node representative of the second file, the first weight increasing a likelihood of traversing to the first node and the second weight decreasing a likelihood of traversing to the second node;
traverse the modified graph index by traversing to the first node without traversing to the second node.

6. The system of claim 1, wherein to utilize the first search strategy, the programming instructions are further structured to cause the processor to:
determine a value of a first weight corresponding to the first filter criterion and a value of a second weight corresponding to a second filter criterion based on the first filter criterion being assigned a higher level of priority than the second filter criterion, the value of the first weight higher than the value of the second weight;
generate the modified graph index by:
applying the first weight to the first node of the graph index representative of the first file, the first file satisfying the first filter criterion, and
applying the second weight to a second node of the graph index representative of a second file, the second file satisfying the second filter criterion; and
traverse the modified graph to identify the first node.

7. The system of claim 1, wherein to utilize the second search strategy, the programming instructions are further structured to cause the processor to:
generate the first search result without traversing the modified graph index or the graph index.

8. The system of claim 1, wherein to utilize the second search strategy, the programming instructions are further structured to cause the processor to:
determine whether a number of vectors in a range of vectors representing candidate results has a predetermined relationship with a second predetermined threshold;
when the number of vectors has the predetermined relationship with the second predetermined threshold:
utilize a tree-based range scan as the second search strategy to generate the first search result; and
when the number of vectors does not have the predetermined relationship with the second predetermined threshold:
load data from a document store corresponding to the vectors to generate the first search result.

9. A method performed by a computer-implemented query search system, the method comprising:
receiving, from a computing device, a first query comprising first metadata;
determining a first filter criterion based on the first metadata;
generating a first inverted index based on the first filter criterion, the inverted index indicating a first term of the first metadata and a first file associated with the first term;
determining a first level of selectivity of the first inverted index has a predetermined relationship with a first predetermined threshold;
utilizing a first search strategy to generate a first search result satisfying the first query; and
providing, to the computing device, the first search result.

10. The method of claim 9, wherein said utilizing the first search strategy to identify the first search result comprises:
selecting the first search strategy based on said first level of selectivity of the first inverted index has a predetermined relationship with a first predetermined threshold, the first search strategy configured to reduce compute resources expended in generating the first search result.

11. The method of claim 9, wherein said generating a first inverted index based on the first filter criterion comprises:
accessing first file metadata of the first file;
identifying an instance of the first term in the first file metadata; and
generating the first inverted index based at least on said identifying the instance of the first term in the first file metadata.

12. The method of claim 11, wherein said generating the first inverted index based at least on said identifying the instance of the first term in the first file metadata comprises:
generating a bit set having a first value indicating the instance of the first term is present in the first file metadata and a second value indicating the instance of the first term is not present in second file metadata of a second file; and
generating the inverted index based at least on the bit set.

13. The method of claim 12, wherein said utilizing a first search strategy to generate a first search result satisfying the first query comprises:
applying a first weight to a first node of a graph index and a second weight to a second node of the graph index resulting in a modified graph index, the first node representative of the first file and the second node representative of the second file, the first weight increasing a likelihood of traversing to first node and the second weight decreasing a likelihood of traversing to the second node;
traversing the modified graph index by traversing to the first node without traversing to the second node; and
generating the first search result based at least on a result of said traversing the modified graph.

14. The method of claim 9, wherein said generating the first inverted index comprises:
accessing a previously generated inverted index; and
utilizing the previously generated inverted index as the first inverted index.

15. The method of claim 9, wherein utilizing the first search strategy comprises:
applying the first inverted index to a graph index to generate a modified graph index;
traversing the modified graph index to identify a node of the modified graph index that satisfies the first query; and
generating the first search result based on the identified node.

16. The method of claim 15, wherein said applying the first inverted index to the graph index comprises:
determining a value of a first weight corresponding to the first filter criterion and a value of a second weight corresponding to a second filter criterion based on the first filter criterion being assigned a higher level of priority than the second filter criterion, the value of the first weight higher than the value of the second weight; and
generating the modified graph index by:
applying the first weight to a first node of the graph index representative of the first file, the first file satisfying the first filter criterion, and
applying the second weight to a second node of the graph index representative of a second file, the second file satisfying the second filter criterion.

17. The method of claim 15, further comprising:
receiving a second query comprising second metadata;
determining a second filter criterion based on the second metadata;
generating a second inverted index based on the second filter criterion;
determining a second level of selectivity of the second inverted index has a different predetermined relationship with the first predetermined threshold;
utilizing a second search strategy to generate a second search result satisfying the second query.

18. The method of claim 17, wherein said utilizing the second search strategy comprises:
determining whether a number of vectors in a range of vectors representing candidate results has a predetermined relationship with a second predetermined threshold;
when the number of vectors has the predetermined relationship with the second predetermined threshold:
utilizing a tree-based range scan as the second search strategy to generate the second search result; and
when the number of vectors does not have the predetermined relationship with the second predetermined threshold:
loading data from a document store corresponding to the vectors to generate the second search result.

19. A query search computing device comprising:
a processor;
a filter determiner that causes the processor to:
receive, from another computing device, a query comprising metadata,
determine a filter criterion based on the metadata, and
generate an inverted index based on the filter criterion;
a strategy selector that causes the processor to:
determine a level of selectivity of the inverted index has a predetermined relationship with a predetermined threshold, and
select a search strategy based on the determination of the level of selectivity having a predetermined relationship with the predetermined threshold; and
a result searcher that causes the processor to:
utilize the selected search strategy to generate a search result satisfying the query, and
provide, to the another computing device, the search result as a response to the query.

20. The query search computing device of claim 19, wherein:
the strategy selector causes the processor to select a graph traversal search strategy when the level of selectivity is above the predetermined threshold and select an alternative search strategy when the level of selectivity is below the predetermined threshold; and
the result searcher comprises:
a graph searcher that, when the graph traversal search strategy is selected, causes the processor to:
apply the inverted index to a graph index to generate a modified graph index,
traverse the modified graph index to identify a node satisfying the query, and
generate the search result based on the node, and
a non-graph-based searcher that, when the alternative search strategy is selected, causes the processor to:
generate the search result without traversing the graph index.
